(19) United States
(12) Patent Application Publication
(10) Pub. No.: US 2017/0046529 A1
(43) Pub. Date: Feb. 16, 2017

(54) APPARATUS SYSTEM AND METHOD

(71) Applicant: SHAREWELL LTD, London (GB)

(72) Inventors: JAMIE ADRIAN AVI-DAN, London (GB); ANDREA ALEXANDRA CHUTE, London (GB); JONATHAN DESMOND RICKETTS, London (GB)

(73) Assignee: Sharewell Ltd, London (GB)

(21) Appl. No.: 14/825,694

(22) Filed: Aug. 13, 2015

(51) Int. Cl. G06F 21/62; H04L 29/06

(52) U.S. Cl. CPC G06F 21/6218; H04L 63/102

(57) ABSTRACT

There is disclosed apparatus operative to provide intermediary gateway control for access to an item stored on a third party shareable data store, the apparatus operative to receive identification data identifying a first user having share access control to one or more items stored on a third party shareable data store. The apparatus is further operative to establish access rights to the third party shareable data store utilising access rights of the first user for accessing the one or more items on the third party shareable data store; store the access rights in a first user data structure; and to receive restriction information for the first user and to store the restriction information in association with the first user. Such apparatus provides a technical environment in which access to a shareable data item or items may be controlled by an intermediary using a first user's (sharer's) access credentials. Providing such a technical environment gives an intermediate gateway function separating a second user from the first user's access credentials to the third party shareable data store thereby facilitating denial of access to the item by the second user simply by closing the second user's access through the apparatus.

### FIELD

The invention relates to an apparatus, system and method for enabling access to an item on a data store.

### BACKGROUND

Virtual collaboration between large numbers of parties is becoming more and more popular due to the proliferation of the internet enabling fast, reliable communication over long distances. This has led to an increase in cross territory collaboration on documents which may be of a sensitive nature or documents that may be the product of prior agreement between collaborating parties. The collaboration on the documents may generically be considered a process but is referred to herein as a “workflow” and a particular instance of a document considered a product of the workflow up to the instance. Such documents may include legal agreements, patent specifications, licensing agreements and any other document which may require substantial correspondence before agreement is reached on its content. The security of and control of access to such documents in a workflow is of great importance.

United States Patent Application Publication Number US 2013/0117376 A1 relates to systems and/or techniques that provide for an entity to collaborate on a document with another entity. A first entity may generate a document and upload that document to a third party data repository. The first entity may then elect to share that document with one or more other entities by inviting those one or more other entities to share by sending an email to the other entities containing details of a hyperlink corresponding to the document in the third party data repository.

International Patent Application Publication Number WO 2013/173111 A2 relates to cloud based data item sharing and collaboration amongst groups of users. A system is disclosed in which a data item is assigned to a collection of other data items which is assigned to a group of subscribing users. Each of the users in the group receives a local copy of the data item which is stored locally. Each time a modification is made to the data item the modification is sent to each of the devices and the modification is merged with the local copy stored on respective local devices.

Google, Inc. (herein after “Google”) currently offer the Google Docs and Google Drive services that enable parties geographically distant from each other to create and share documents. Google Drive provides a cloud based service that provides storage for a user's files. Google Docs (integrated into Google Drive) provides a document preparation service in which a group of users can collaborate on documents. Google Drive provides a service by which documents that are stored on Google Drive can be shared with others.

A lack of control exists over access to data items that are shared during workflows. For example, maintaining the security and integrity of shared documents in particular within a defined access rights relationship.

Aspects and embodiments in accordance with the invention were devised with the foregoing in mind.

### SUMMARY

Viewed from a first aspect there is provided apparatus operative to provide intermediary gateway control for access to an item stored on a third party shareable data store, the apparatus operative to: receive identification data identifying a first user having share access control to one or more items stored on a third party shareable data store; establish access rights to the third party shareable data store utilising access rights of the first user for accessing the one or more items on the third party shareable data store; and store the access rights in a first user data structure.

Viewed from a second aspect there is provided a method of operating data processing apparatus to provide an intermediary gateway control for access to an item stored on a third party shareable data store, the method comprising: receiving identification data identifying a first user having share access control to one or more items stored on a third party shareable data store; establishing access rights to the third party shareable data store utilising access rights of the first user for accessing the one or more items on the third party shareable data store; and storing the access rights in a first user data structure.

An embodiment in accordance with the first or second aspect provides a technical environment in which access to a shareable data item or items may be controlled by an intermediary using a first user's (sharer's) access credentials. Providing such a technical environment gives an intermediate gateway function separating a second user from the first user's access credentials to the third party shareable data store thereby facilitating denial of access to the item by the second user simply by closing the second user's access through the apparatus.

The first user may be authenticated with the third party shareable data store in order to establish the access rights. Authentication provides verifiable access of the first user to the third party shareable data store and provides the mechanism by which access to the third party shareable data store may be permitted or denied to a second user.

The access rights may comprise an access token provided by the third party shareable data store for storage in the first user data structure. The access token may be configured to enhance the access control functionality provided by the third party shareable data store. For example, the usual access rights to read or modify an item may be limited or the services associated with access enhanced in some respect such as a second user being billed per access event.

One or more embodiments may receive restriction information for the first user and to store the restriction information in association with the first user. Such restrictions may be making the item available only for a certain period of time or when accessed from a particular domain, or not available when accessed from a particular domain.

The restriction information may be stored in a restriction table and relate first user data structure to the restriction table, Such as in a relational database.

The restriction information may be indexed in the restriction table by a first user id information. This ensures that the restrictions are first user based and defined for the first user so that they will always be carried through to any sharing with the second user.

The restriction information may be of a first or second type and one or more embodiments may store in respective fields of the first user data structure a label for a respective one of the first or second type; store in respective first and second restriction tables corresponding to each of the first and second type of restriction data defining one or more specific restrictions of the respective first and second type; and index the respective fields of the first data structure with corresponding restriction data in respective first and second restriction tables by the first user id data.

This may provide for more than one type of restriction and enhances the flexibility of the apparatus in terms of access control.

One or more embodiments may receive from the first user identification data identifying a second user; receive information representative of the storage location in the third party shareable data store of at least one item of the one or more items responsive to selection of the at least one item by the first user; generate a key unique to the at least one second user and representative of the storage location in the third party shareable data store of the at least one item; store a concordance of the unique key and the information representative of the storage location for the at least one item; store the unique key in a record of a first user workflow data structure, the first user workflow data structure further comprising a record identifying the second user; index the first user data structure with the workflow data structure through the first user id data; and provide the unique key to the second user identified in the workflow data structure.

The unique key may be provided to the second user to allow the second user to identify the item to be shared without identifying the origin of the data storage location. The key can be used to prevent access by the second entity to the item as the key is unique to the second entity and not to any other entity. Other entities may also be given unique keys. This enables control over access to the item.

The unique key may be used to prevent access to the item subject to a condition which is based, for example, on data from an external data source or on a geographically based condition such as an IP address.

One or more embodiments may identify the information representative of the storage location for the at least one item responsive to a second user supplying the unique key to the apparatus and redirecting the second user to a storage location on the third party shareable data storage corresponding to the information representative of the storage location for the at least one item. Thus the second user is not provided with the location of the item in the third party data store thereby maintaining the separation of the location of the item and access to the item.

In particular embodiments the information representative of the storage location for the at least one item may be encrypted. Such encryption not only provides security from external attack but also separates the location information from the apparatus itself. For example, the location information may be encrypted programmatically when retrieved from the third party shareable data store and therefore only have transient presence in the apparatus.

Suitably, the encrypted information representative of the storage location for the at least one item is decrypted responsive to initiation of redirecting the second user. Decryption occurs when looking to redirect a second user and again may be done programmatically so that the location information is only transiently present in the apparatus.

As restrictions may change and be updated one or more embodiments may inspect a restriction associated with the first user to determine applicability of the restriction to the second user so that the access control can be maintained current. In such embodiments access by the second user to the at least one item may be restricted in accordance with a restriction applicable thereto.

A time stamp may be recorded in the workflow data structure responsive to instantiation of the workflow data structure. Thus a restriction may only apply for or be invoked based on a time, for example the time a collaborative project exists. In such an arrangement, an embodiment may restrict access to the at least one item responsive to a time period from the date stamp having elapsed.

One or more embodiments may remove concordance of the unique key and the information representative of the storage location for the at least one item to inhibit access of the second user to the at least one item. By removing the concordance the second user cannot have access through their unique key because it is not correlated with anything in the apparatus. Therefore, no redirection can occur.

Removal of the concordance comprises inhibiting the unique key in the workflow data structure which is a particularly straightforward way of removing concordance. Inhibiting the unique key may comprise deleting it from the workflow data structure.

Following removal of concordance, an embodiment may request the third party shareable data storage to deny access to the at least one data item by the second user. Thus, if a second user has been denied access through the apparatus for some reason the apparatus will automatically communicate to the third party shareable data storage a commensurate request to deny access to that second user. Such denial of access is by using the first user's credentials in the third party shareable data store to deny access to the second user.

One or more embodiments may record all interactions between the first user, second user and the at least one item. Such recordal creates a transaction log of all interactions concerning a particular share and allows for auditing of that share. For example, it may be possible to demonstrate access and what type of access was granted if necessary to repudiate an allegation of inappropriate or unauthorised access.

A particular embodiment may maintain a subscription log logging access to the at least one item through the apparatus; request a transaction log listing access to the at least one item on the third party shareable data store; compare the transaction log to the subscription log; and restrict access to the at least one item based on the comparison. In this way, an embodiment may identify access to the item on the third party shareable data store not authorised by the first user and at the very least not through the apparatus which itself may be a contravention of the second user's permissions.

Such a particular embodiment may be configured to restrict access for the comparison indicating a first user access rights being utilised to access items on the third party shareable data storage other than from the apparatus. Optionally, such an embodiment may restrict access for the comparison indicating a first user access rights being utilised to access items on the third party shareable data storage other than the second user.

Further, such an embodiment may receive updated restriction information and store the updated restriction information in association with the first user.

Suitable, an embodiment may check restriction information at time intervals and update restriction on access for the second user in accordance with changes in restriction information. Optionally or I, an embodiment may set a flag responsive to a change in restriction information and to update restriction on access for the second user in accordance with changes in restriction information responsive to the set flag.

In one or more embodiments data identifying the first user and/or the second user is a data string. The data string may be an email address of the first user and/or second user, optionally the data string is an identity allocated by the apparatus.

### DESCRIPTION

One or more embodiments in accordance with the invention will now be described by way of non-limiting example only and with reference to the following figures, in which:

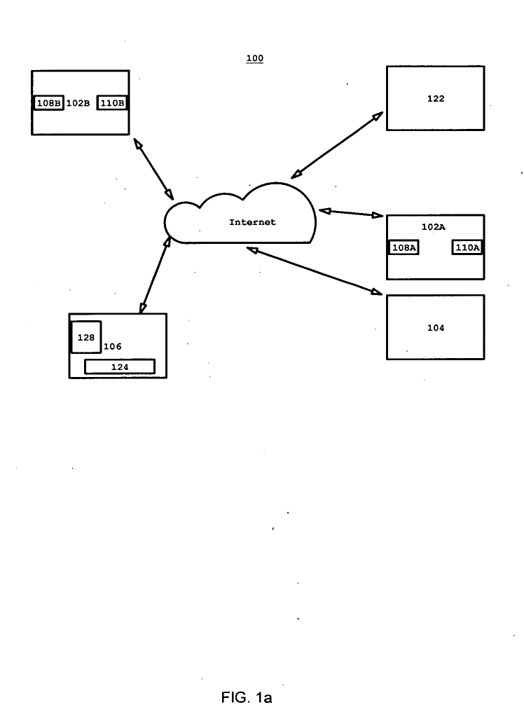

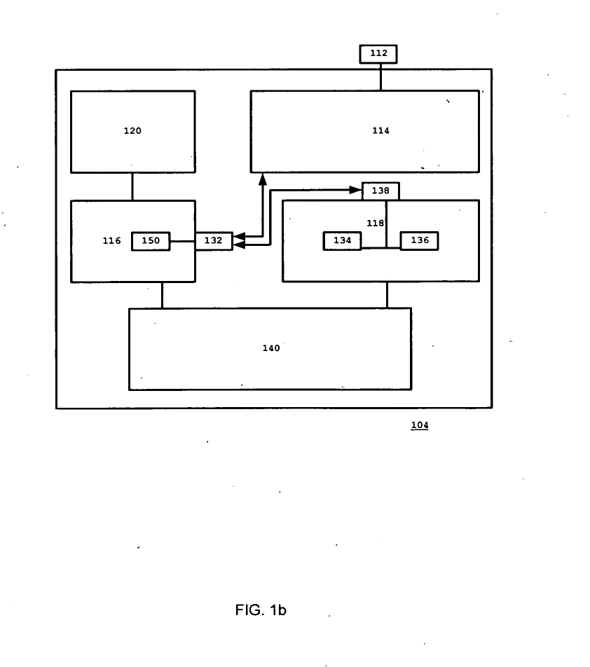

FIG. 1a schematically illustrates an overview of a system comprising an apparatus in accordance with an embodiment of the present invention;

FIG. 1b schematically illustrates a cluster of servers of servers in accordance with an embodiment of the present invention;

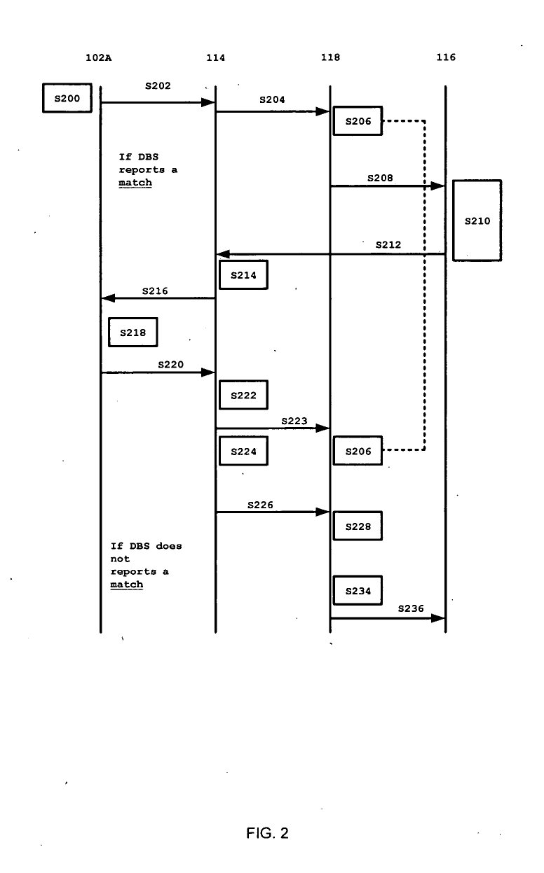

FIG. 2 illustrates a process flow control diagram for establishing a user presence on an apparatus in accordance with an embodiment of the present invention;

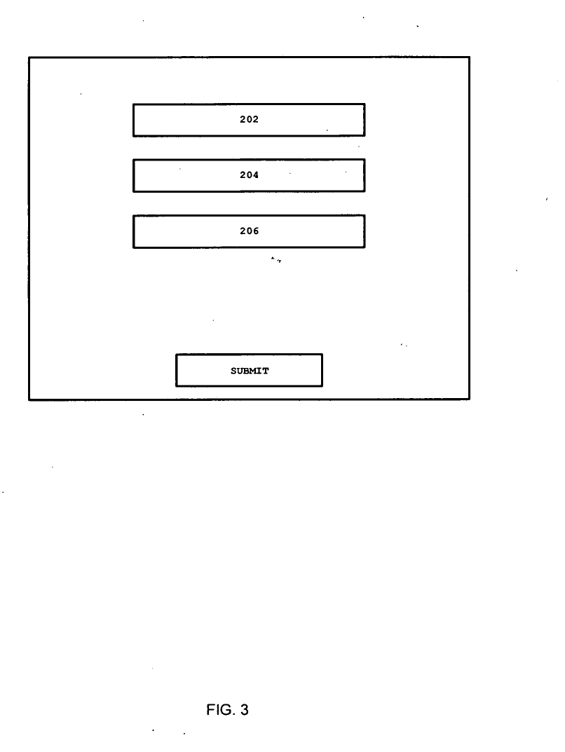

FIG. 3 illustrates a user interface for entering user details to be used in registering a user on a system in accordance with an embodiment of the present invention;

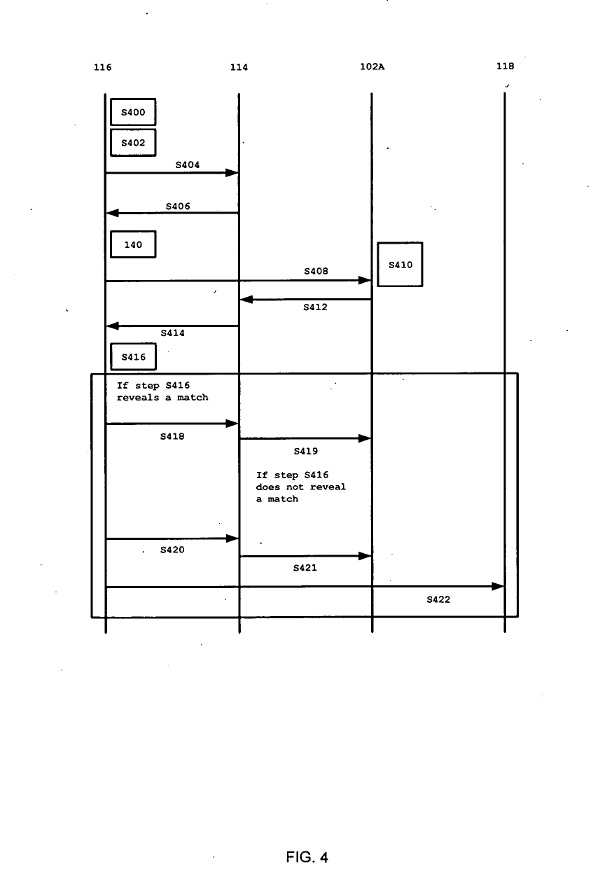

FIG. 4 illustrates a process flow control diagram for the validation of a user on an apparatus in accordance with an embodiment of the present invention;

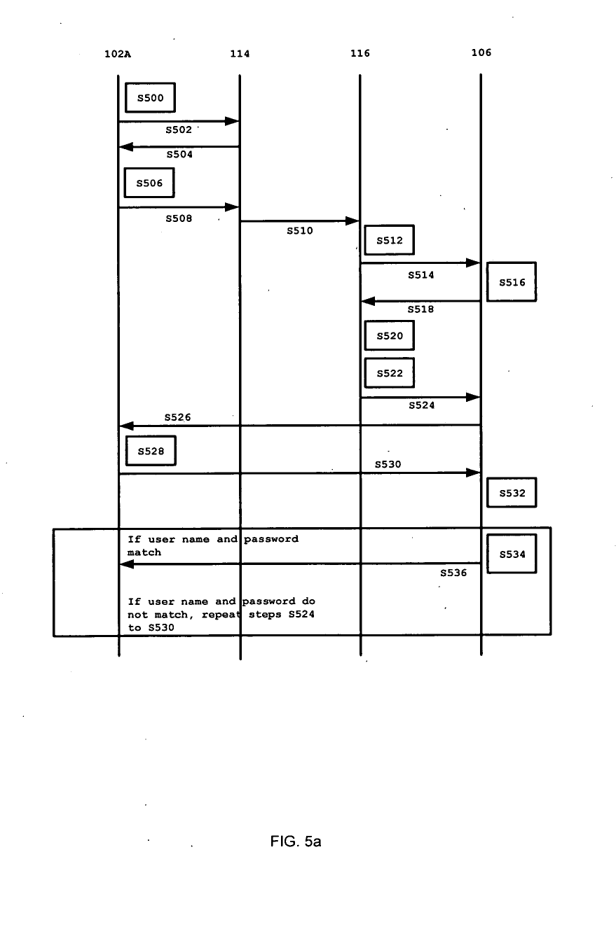

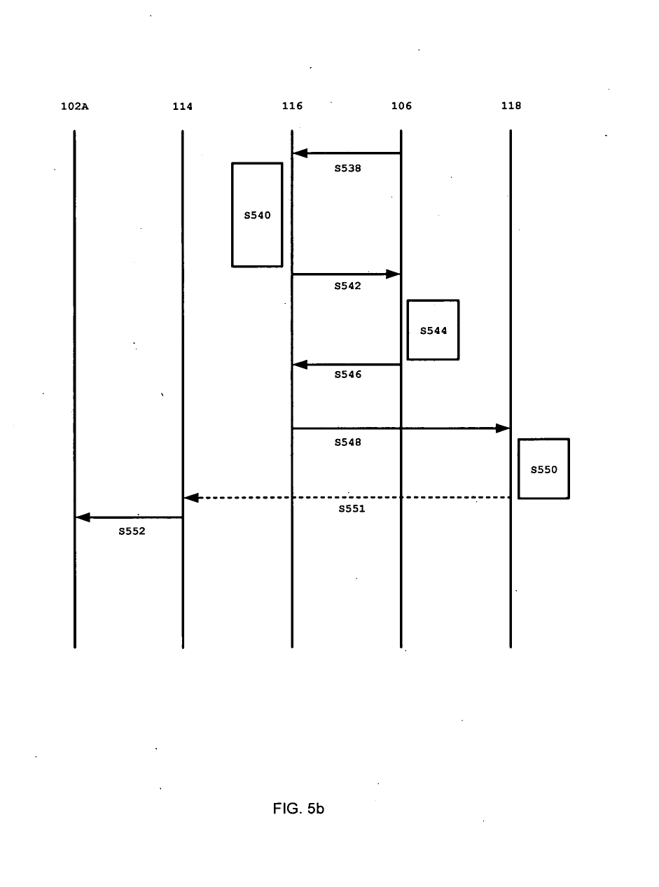

FIGS. 5a and 5b illustrate a process flow control diagram illustrating the authentication of a user on a data store in accordance with an embodiment of the present invention;

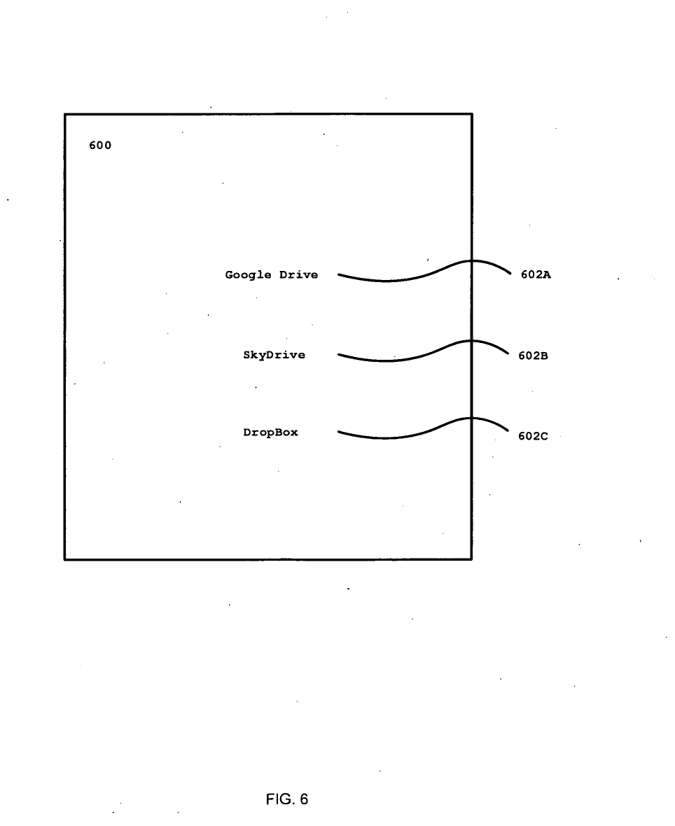

FIG. 6 illustrates a user interface providing a choice of data stores in accordance with an embodiment of the present invention;

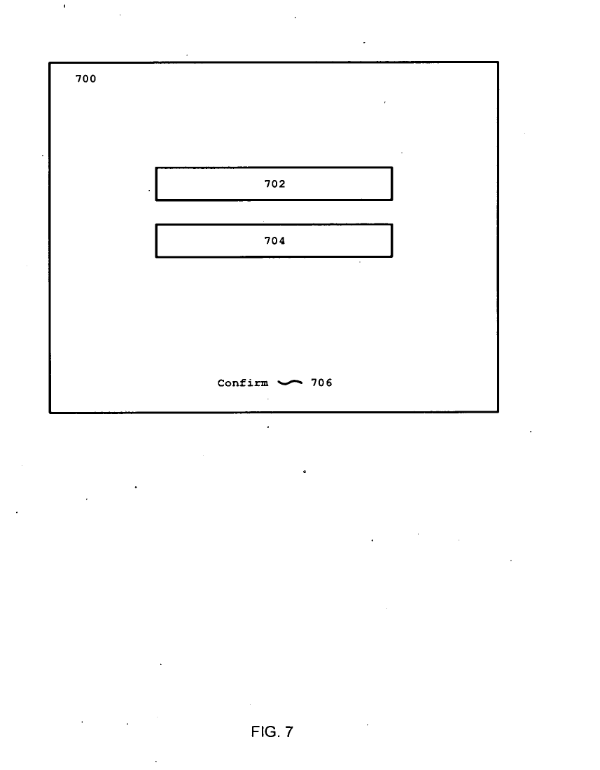

FIG. 7 illustrates a user interface through which authentication details are entered for a data store in accordance with an embodiment of the present invention;

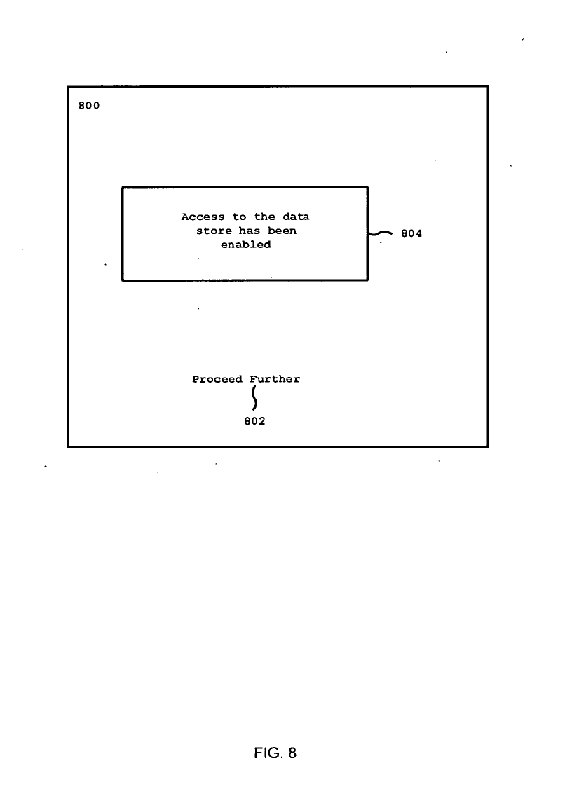

FIG. 8 illustrates a user interface displaying a request that a user indicates if they would like to proceed to initiate a workflow in accordance with an embodiment of the present invention;

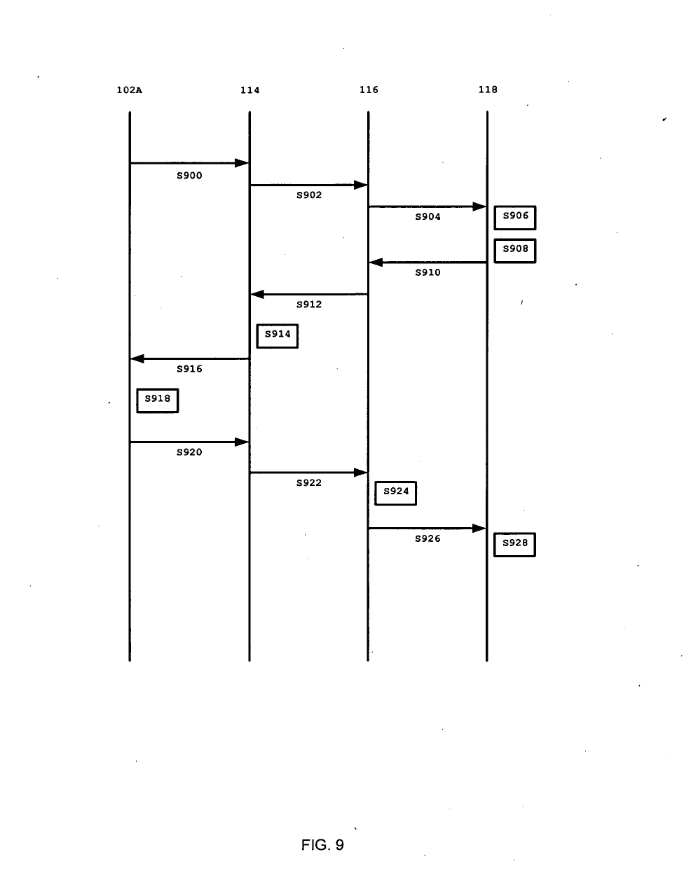

FIG. 9 illustrates a process flow control diagram schematically illustrating a first user inviting a second user to share an item in a workflow in accordance with an embodiment of the present invention;

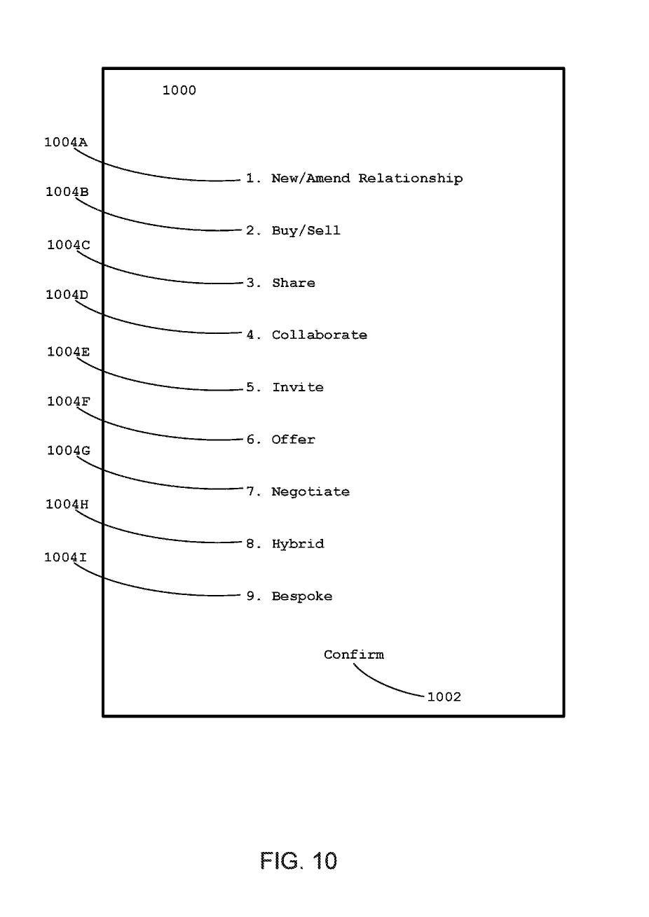

FIG. 10 illustrates a user interface providing a choice of workflows to a user in accordance with an embodiment of the present invention;

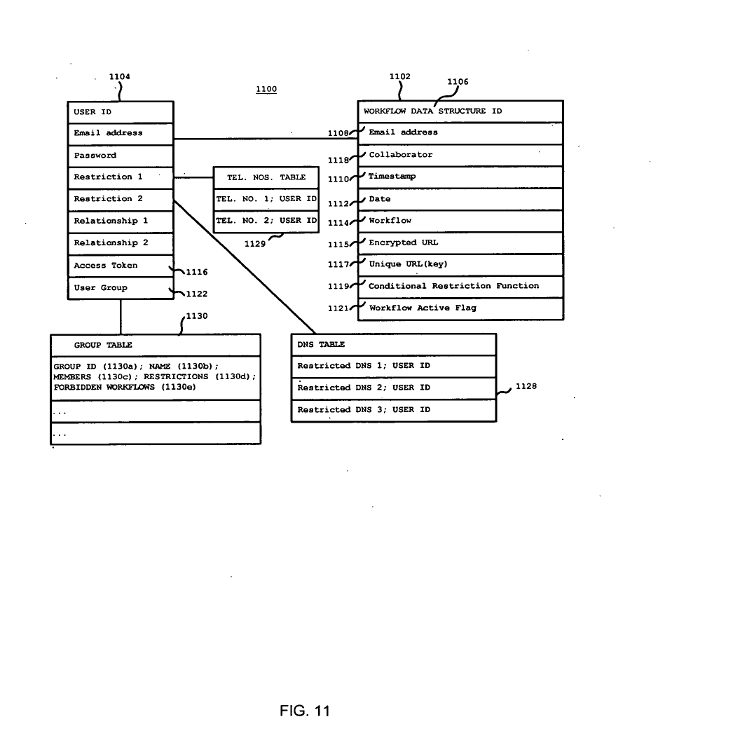

FIG. 11 illustrates a relational database structure used to store the workflows for a user of an apparatus in accordance with an embodiment of the present invention;

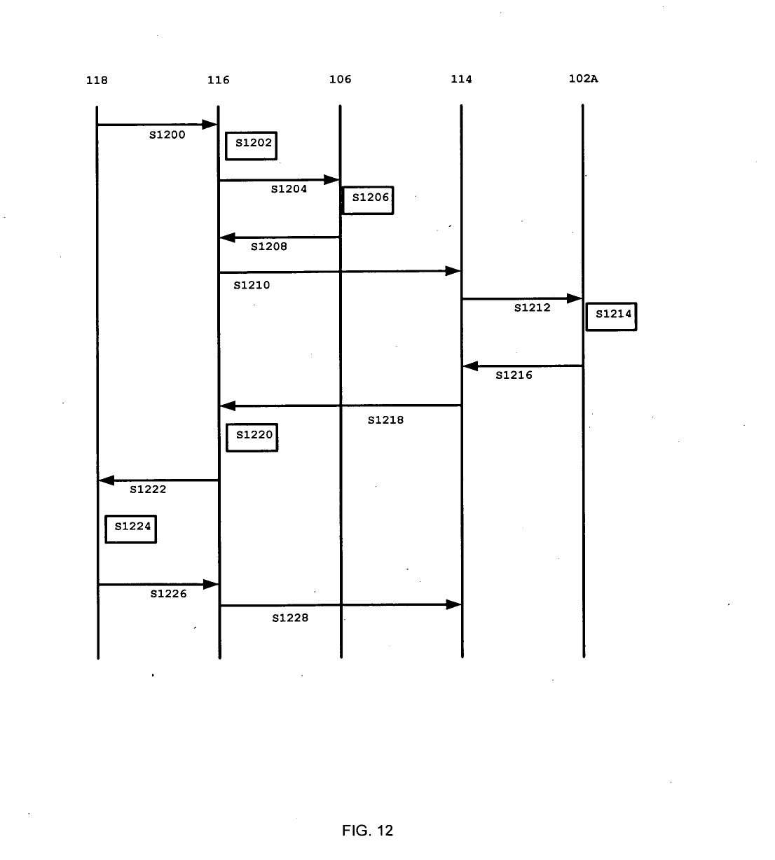

FIG. 12 is a process flow control diagram illustrating how an item is selected for the workflow in accordance with an embodiment of the present invention;

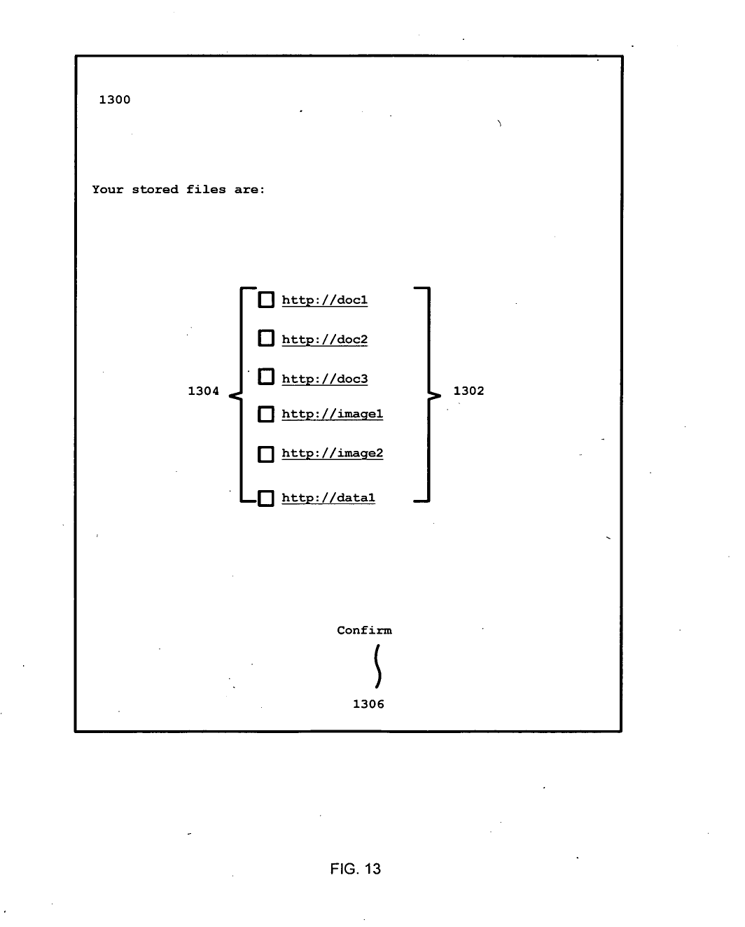

FIG. 13 illustrates a user interface displaying a list of items that may be shared in the workflow in accordance with an embodiment of the present invention;

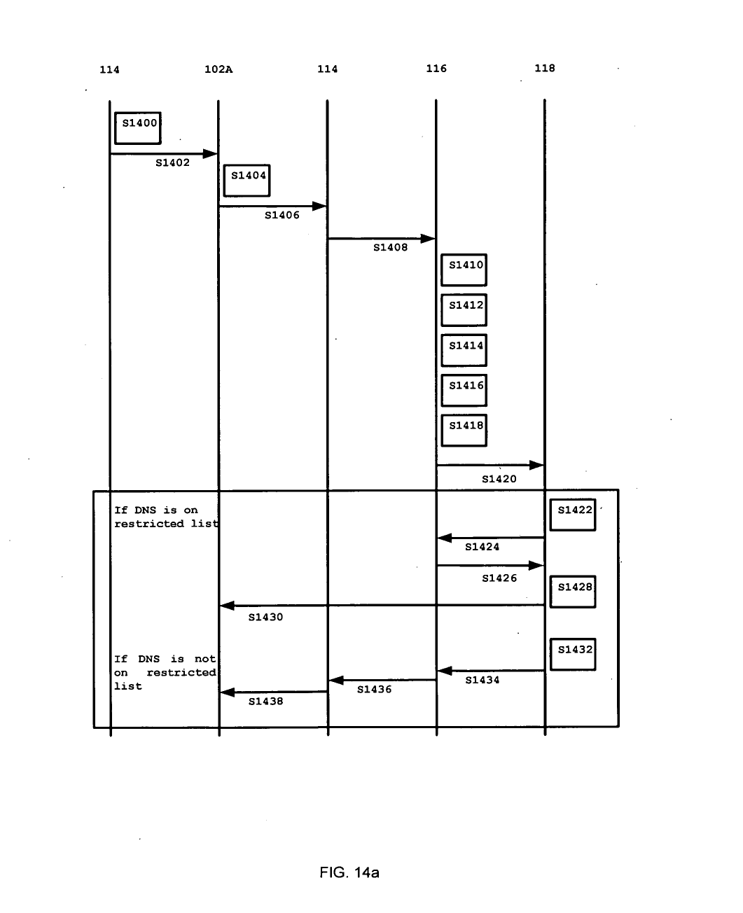

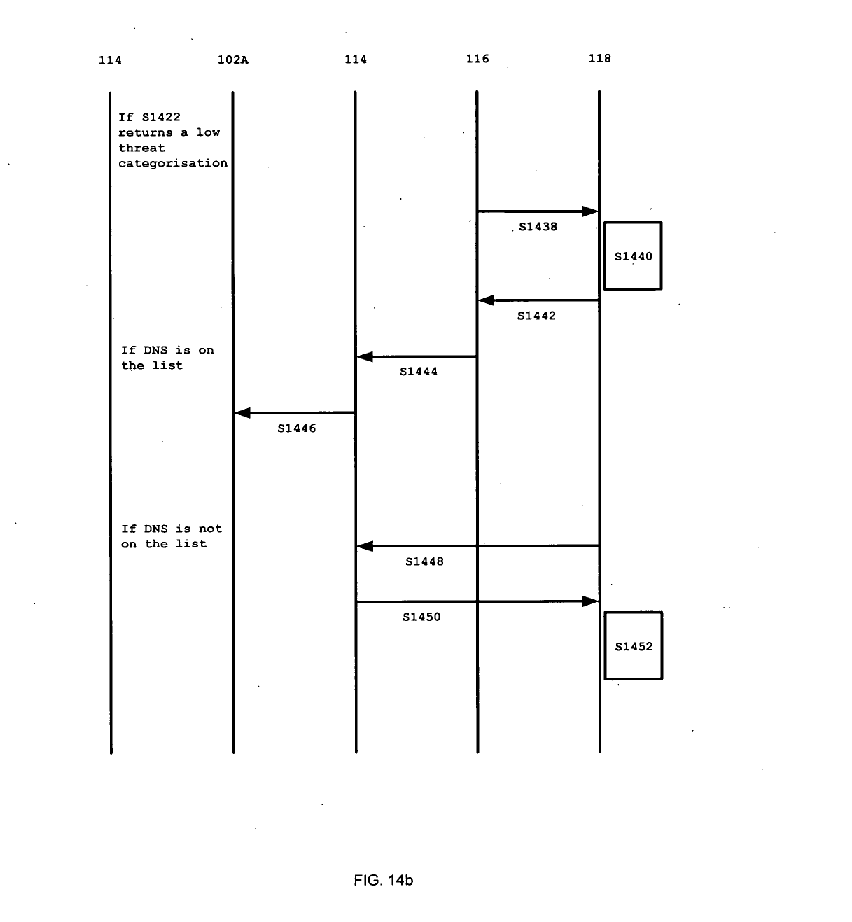

FIGS. 14a and 14b are process flow control diagrams illustrating how an entity is selected for a workflow in accordance with an embodiment of the present invention;

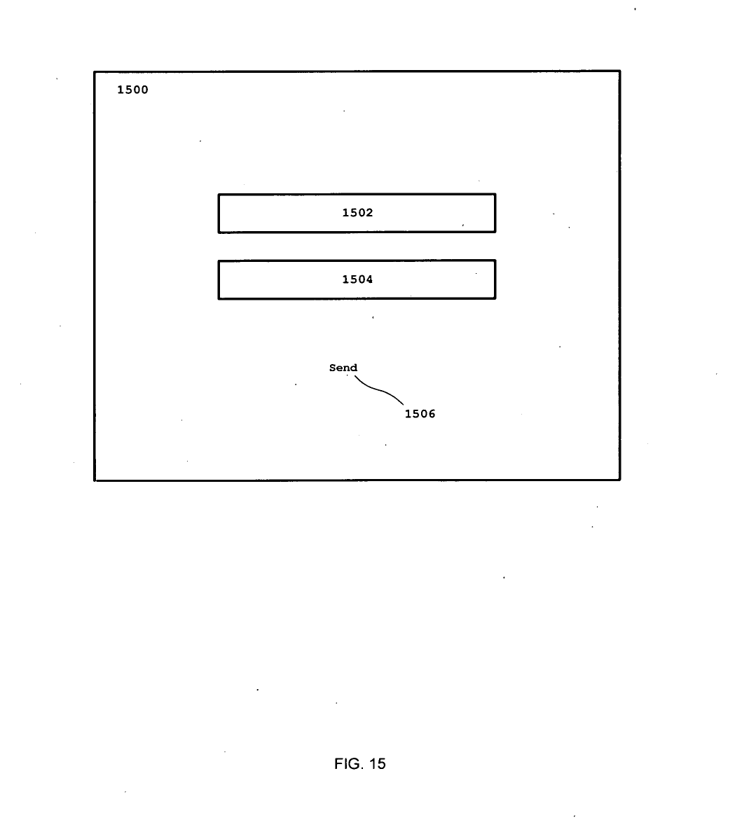

FIG. 15 illustrates a user interface comprising input regions for receiving details of the entity with whom the user would like to invite to the workflow in accordance with an embodiment of the present invention;

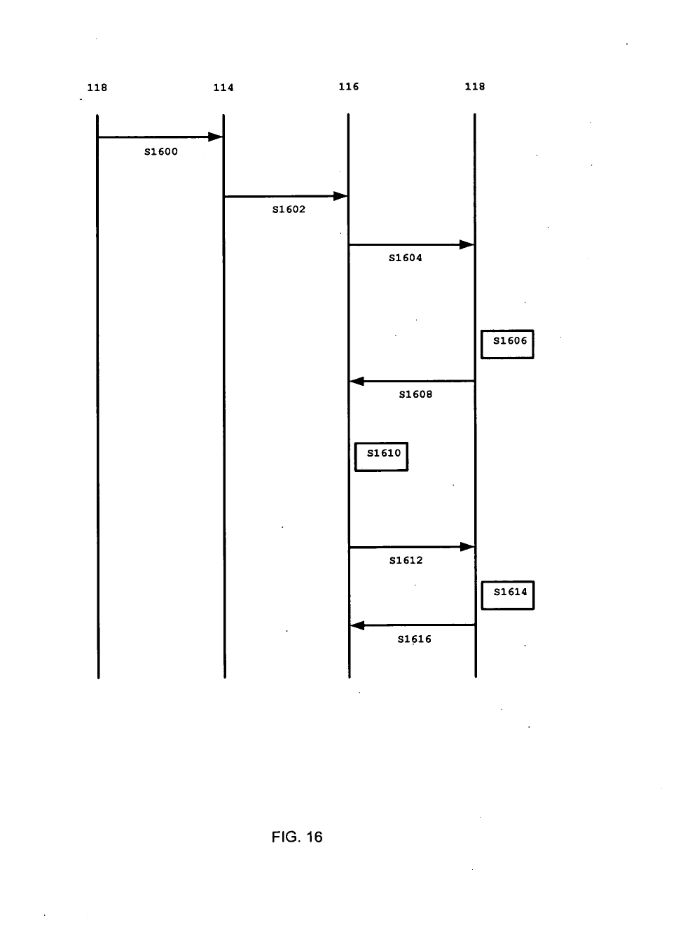

FIG. 16 is a process flow control diagram illustrating how an item is assigned a key in accordance with an embodiment of the present invention;

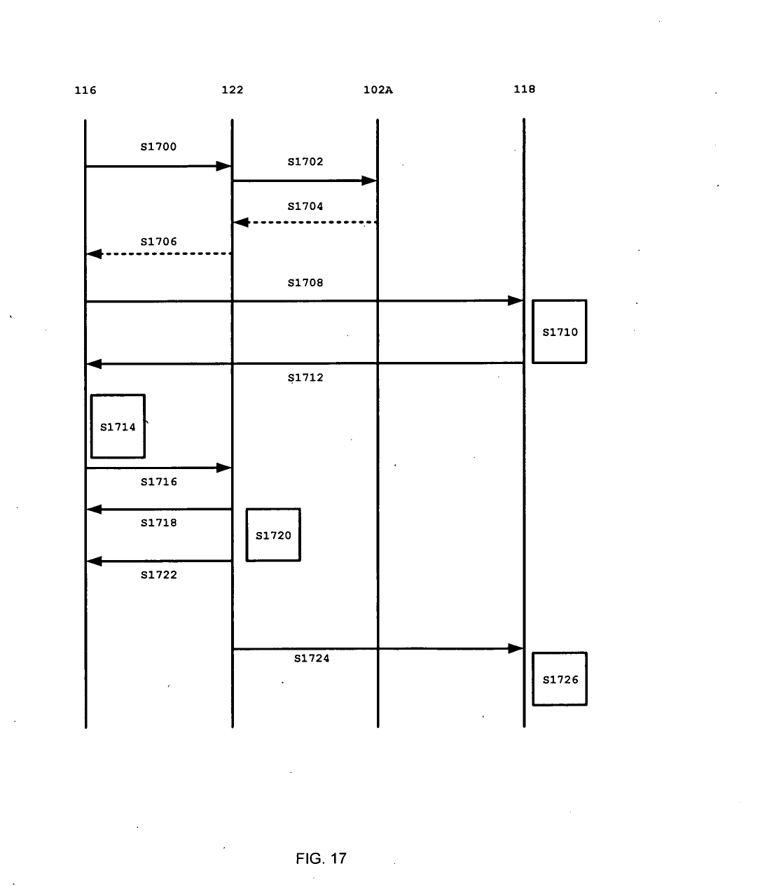

FIG. 17 is a process flow control diagram illustrating the communication of the unique URL to the entity with which the user would like to engage using the initiated workflow in accordance with an embodiment of the present invention;

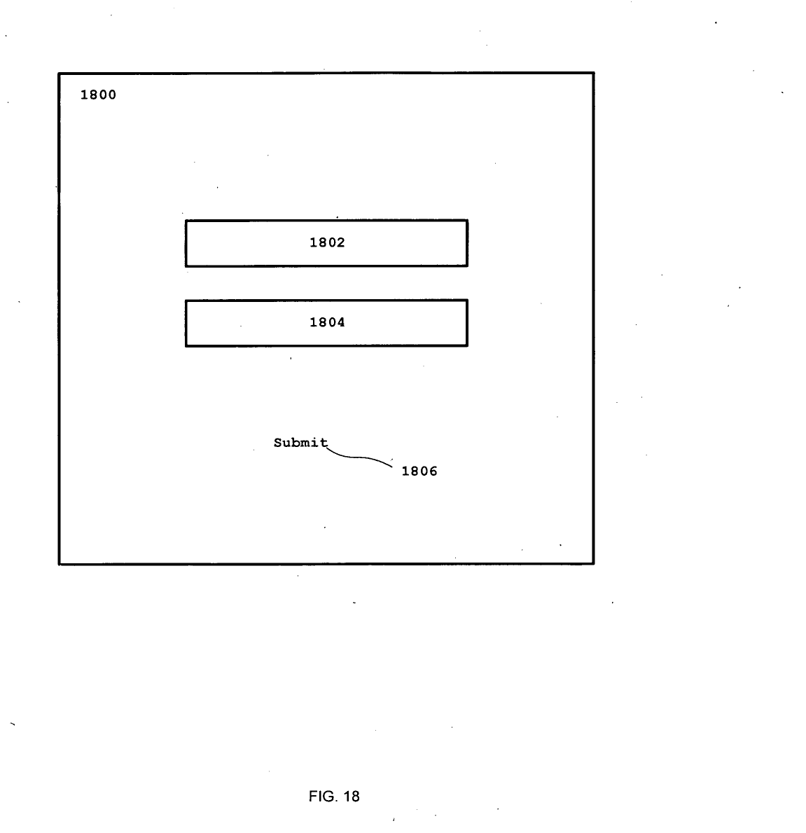

FIG. 18 illustrates a user interface for receiving authentication details for a mail server in accordance with an embodiment of the present invention;

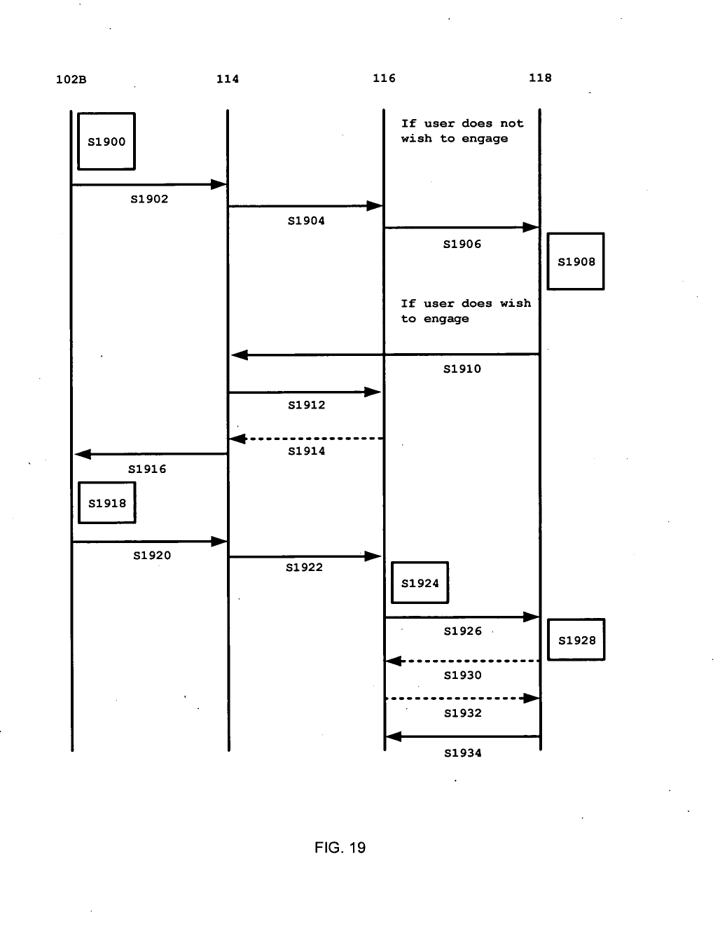

FIG. 19 is a process flow control diagram illustrating how a second user accesses the item as part of the workflow in accordance with an embodiment of the present invention;

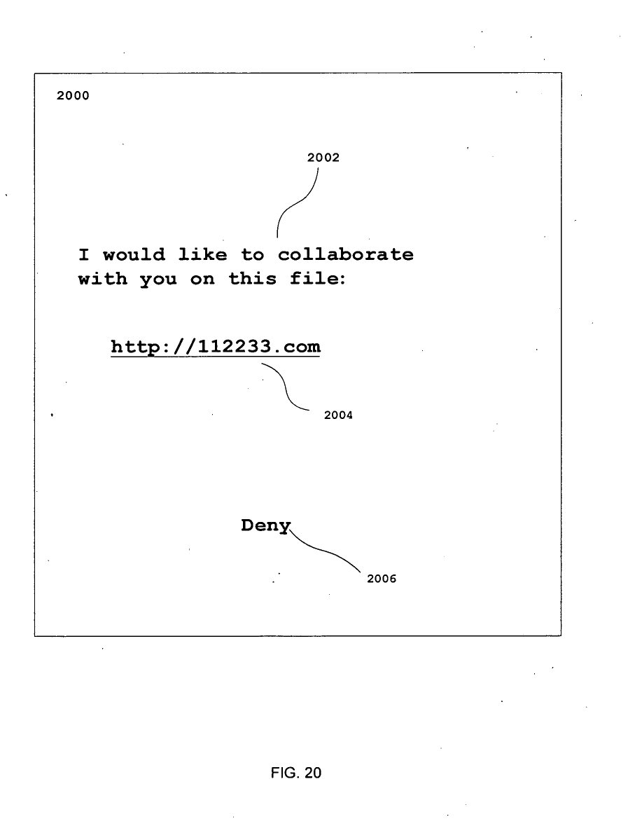

FIG. 20 illustrates presentation of the unique URL to the second user in accordance with an embodiment of the present invention;

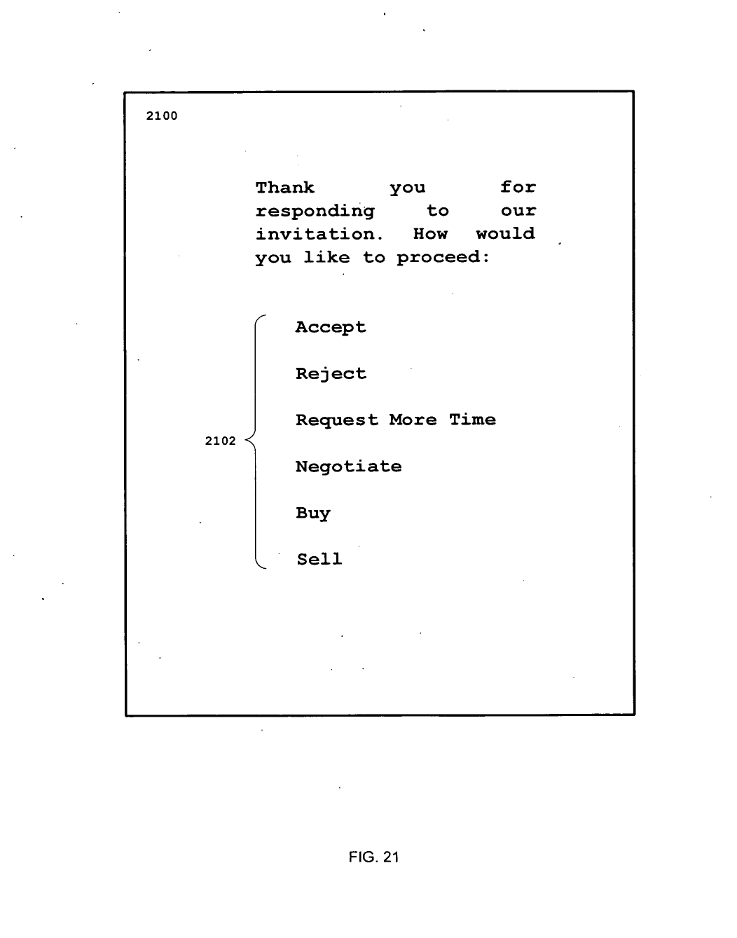

FIG. 21 illustrates the choices available to the second user responsive to the second user selecting the unique URL in accordance with an embodiment of the present invention;

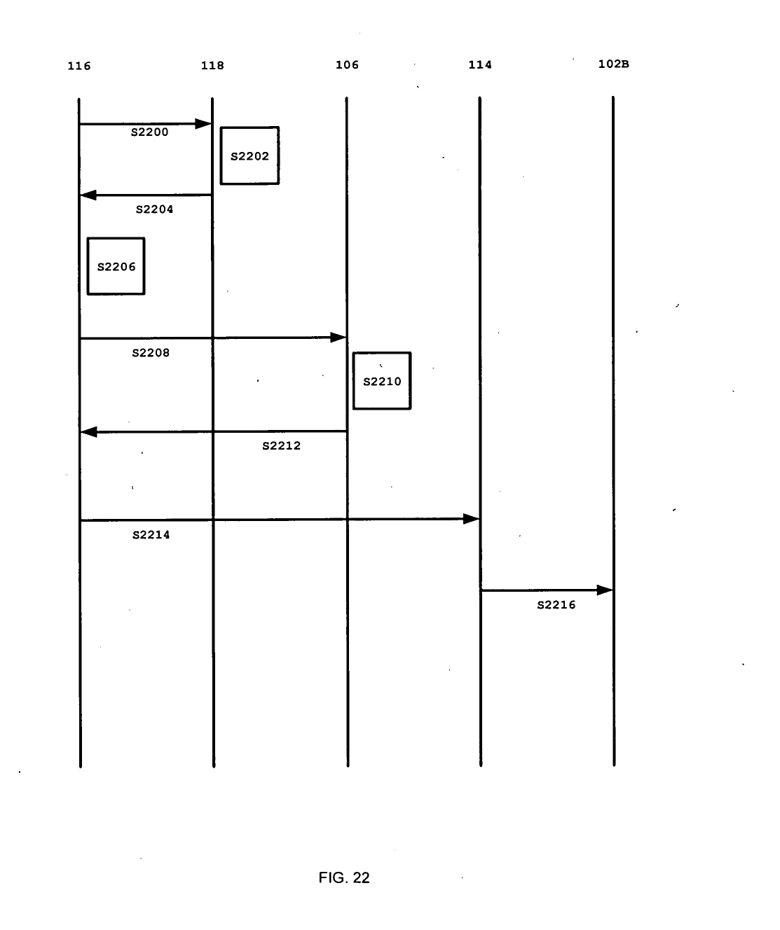

FIG. 22 is a process flow control diagram illustrating how the second user accesses the item using the unique URL in accordance with an embodiment of the present invention;

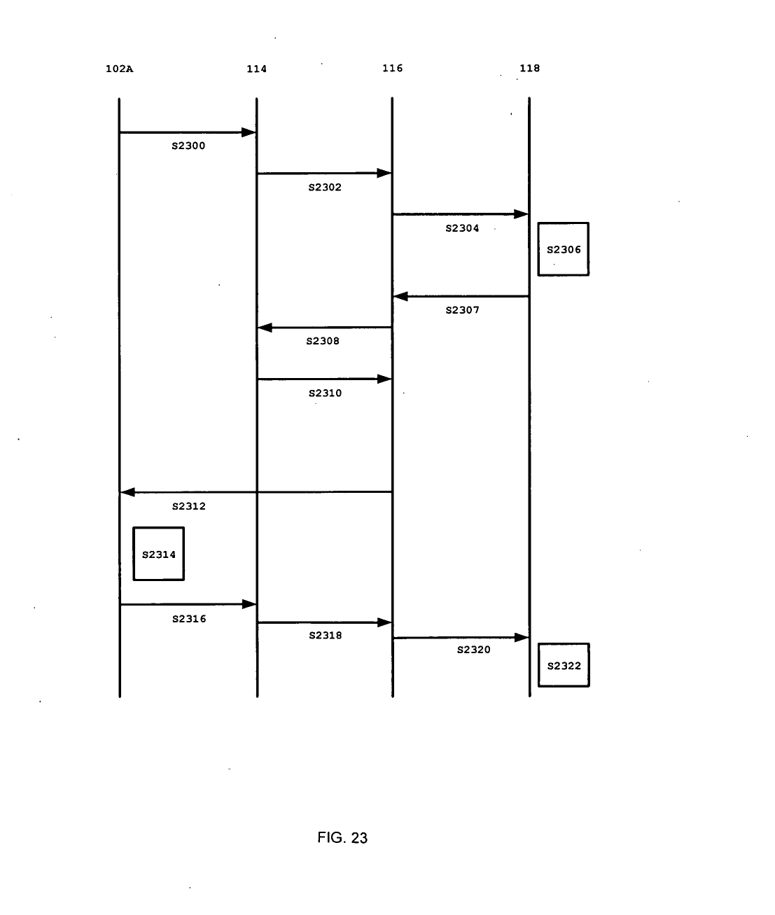

FIG. 23 is a process flow control diagram illustrating how workflows can be restricted by the first user in accordance with an embodiment of the present invention;

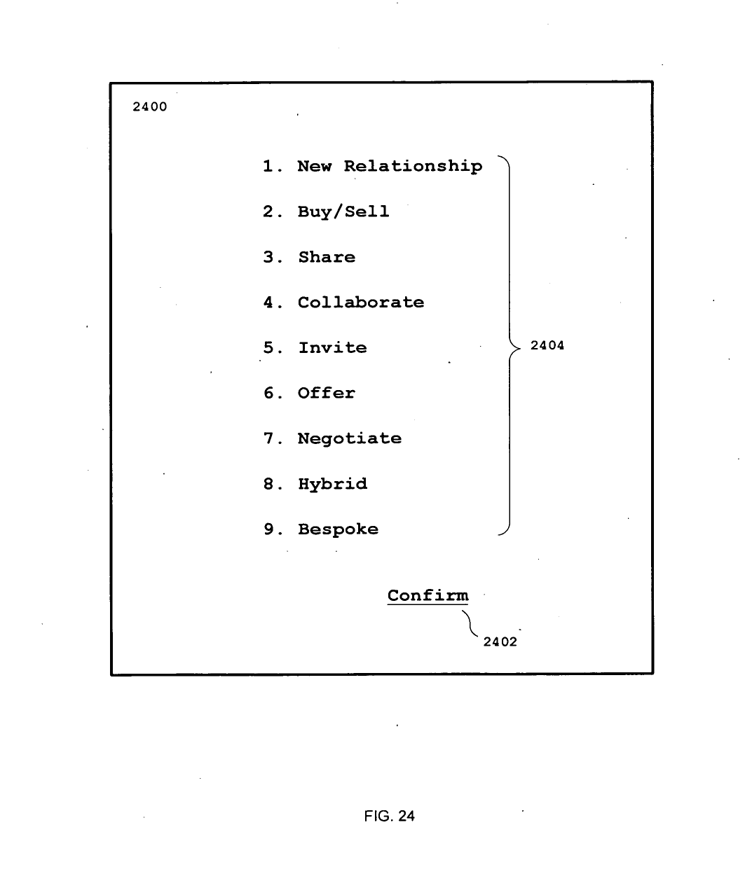

FIG. 24 illustrates the presentation of a restricted choice of workflows as a result of the restrictions on the first user in accordance with an embodiment of the present invention;

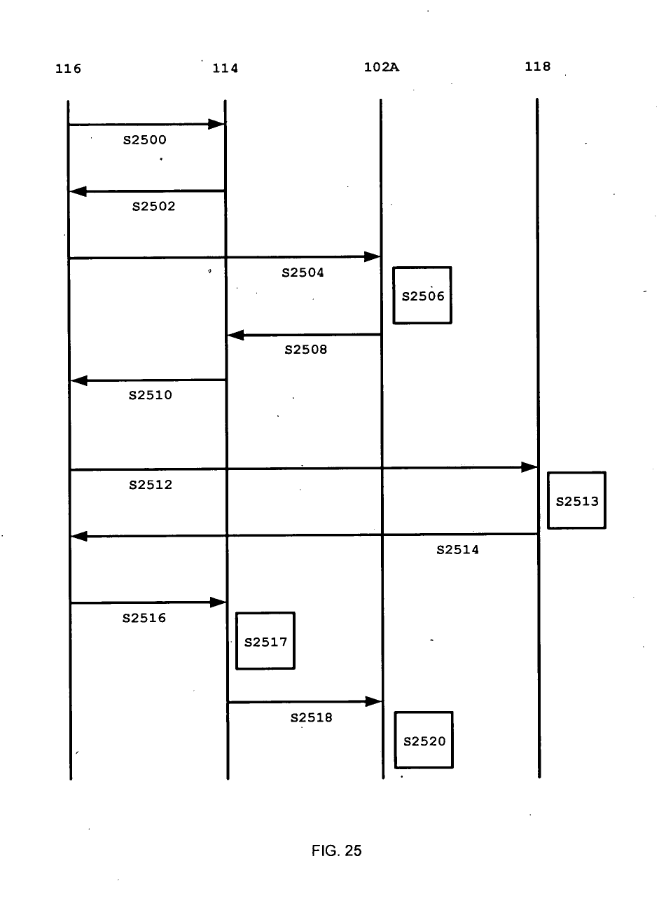

FIG. 25 is a process flow control diagram illustrating the selection of a second entity for a restricted workflow in accordance with an embodiment of the present invention;

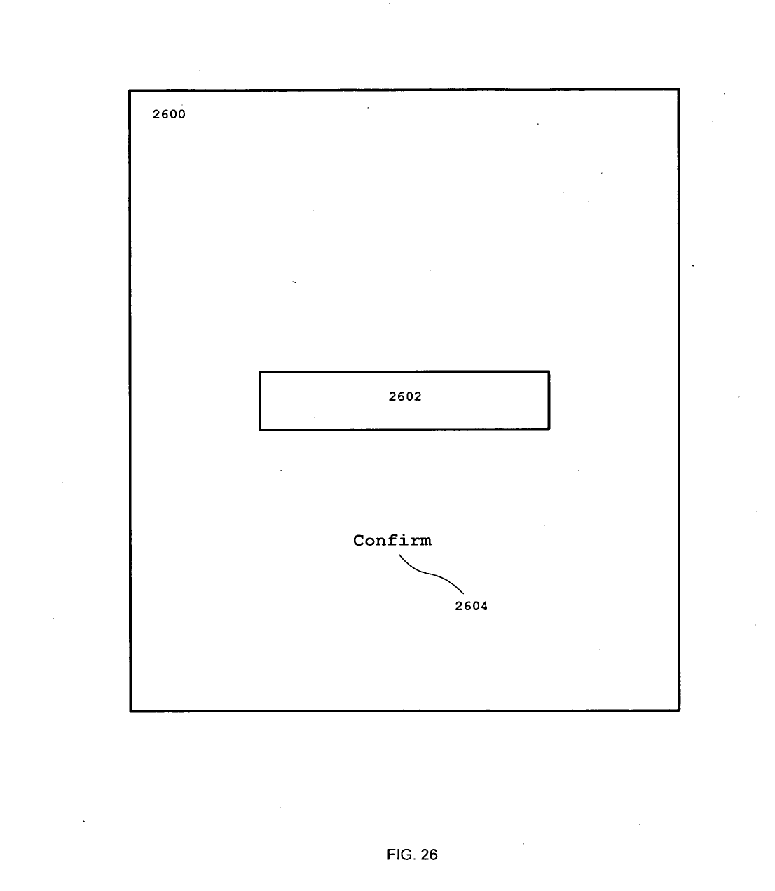

FIG. 26 illustrates a user interface illustrating how the user is asked to submit a different email address for a restricted workflow in accordance with an embodiment of the present invention;

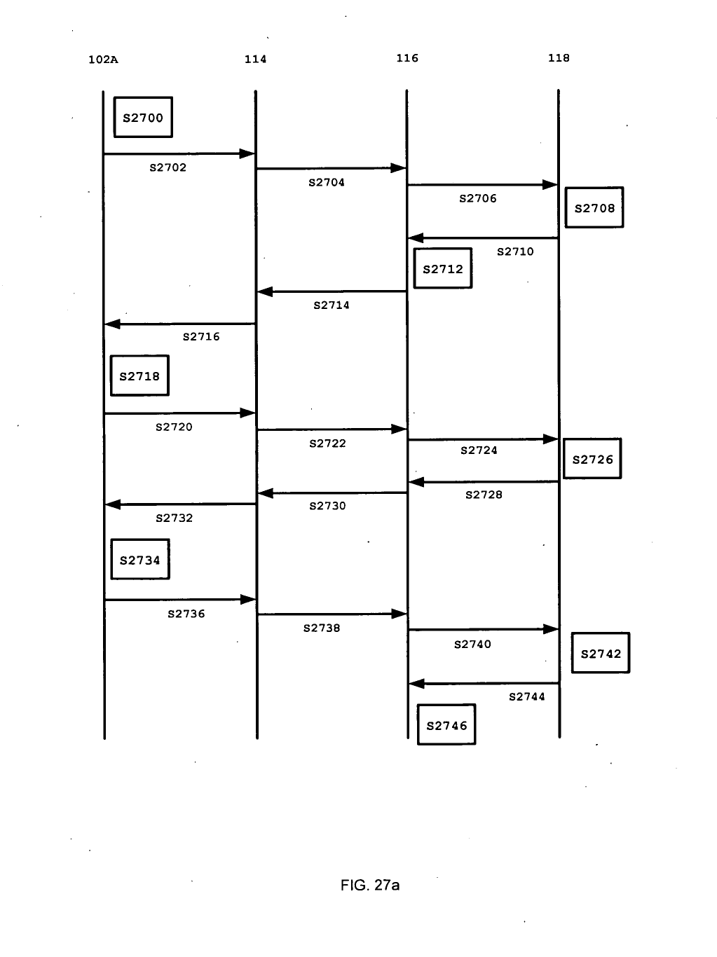

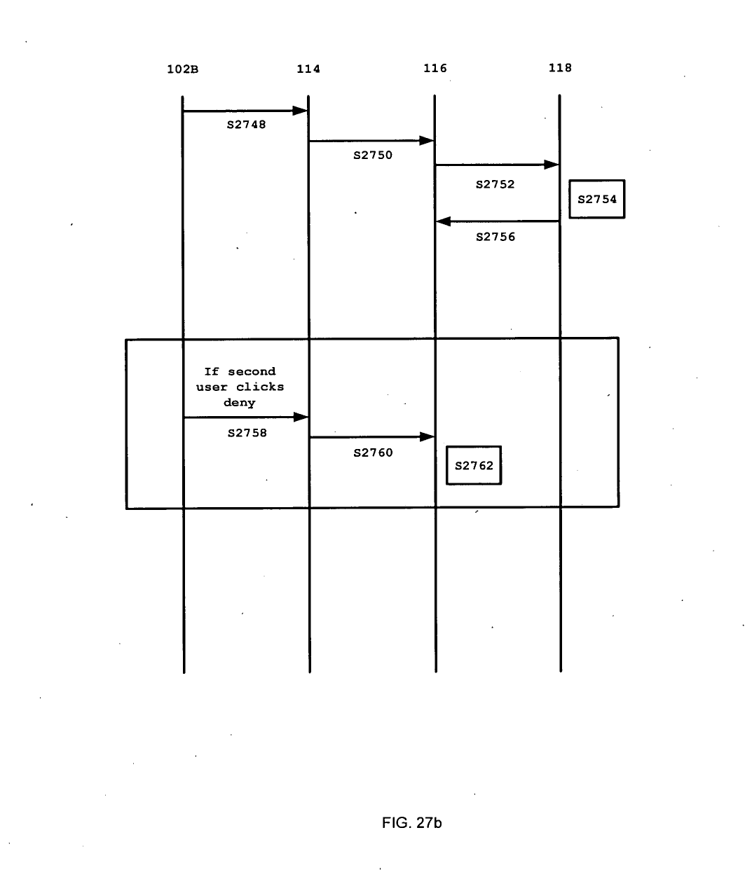

FIGS. 27a and 27b is a process flow control diagram illustrating how a change in the terms and conditions of a workflow can result in a change to that workflow in accordance with an embodiment of the present invention;

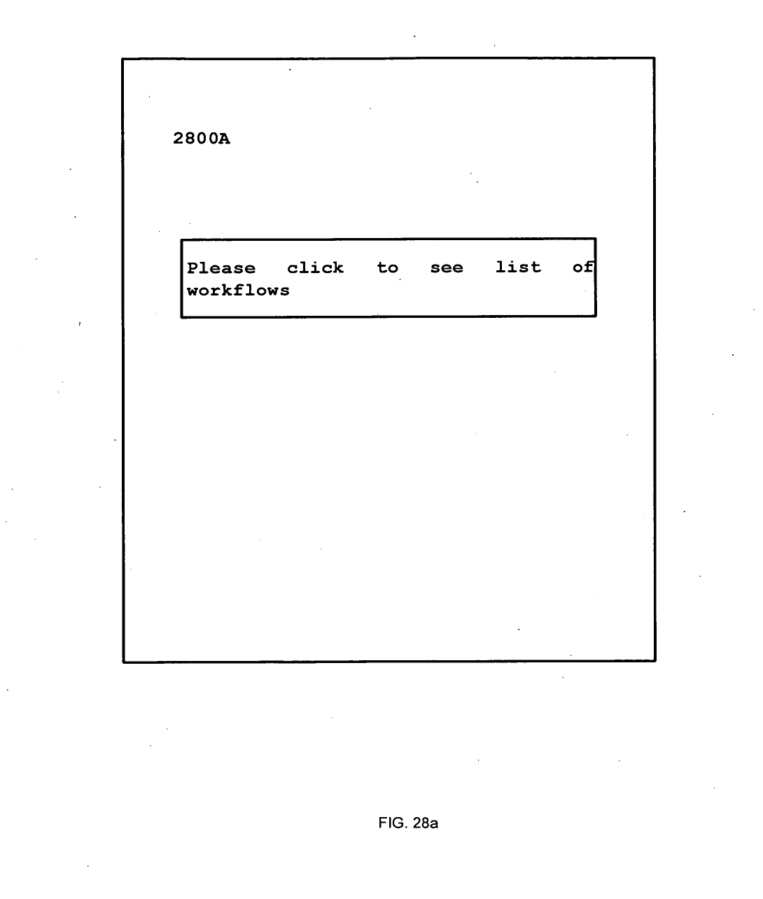

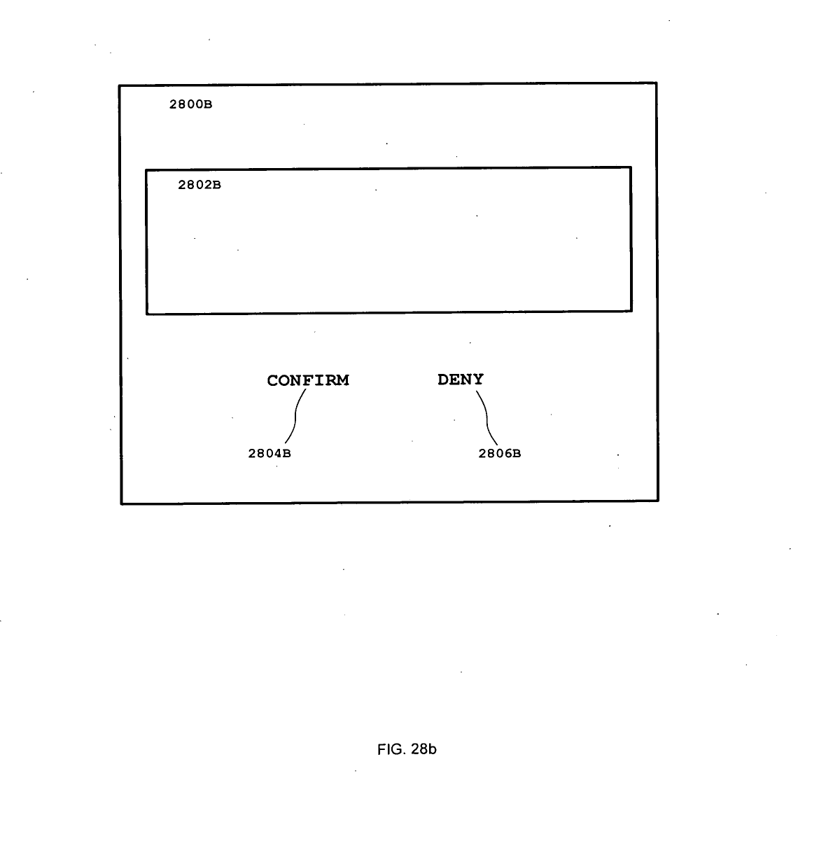

FIGS. 28a and 28b is a user interface for changing the terms and conditions of a workflow in accordance with an embodiment of the present invention; and

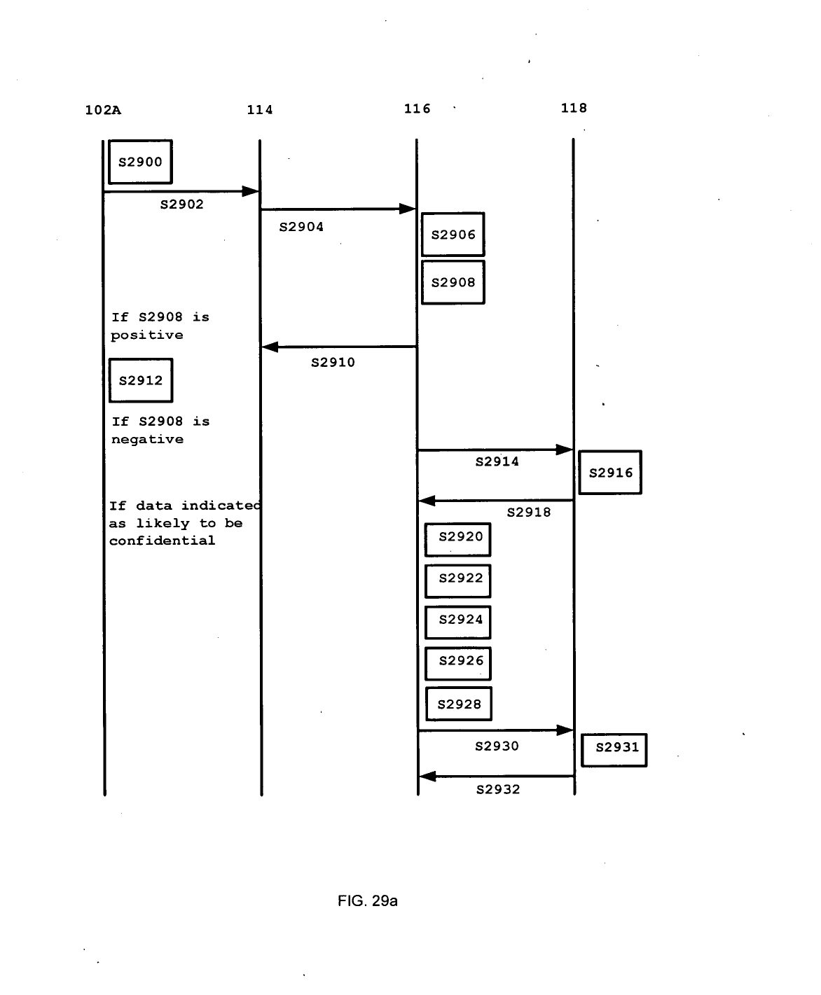

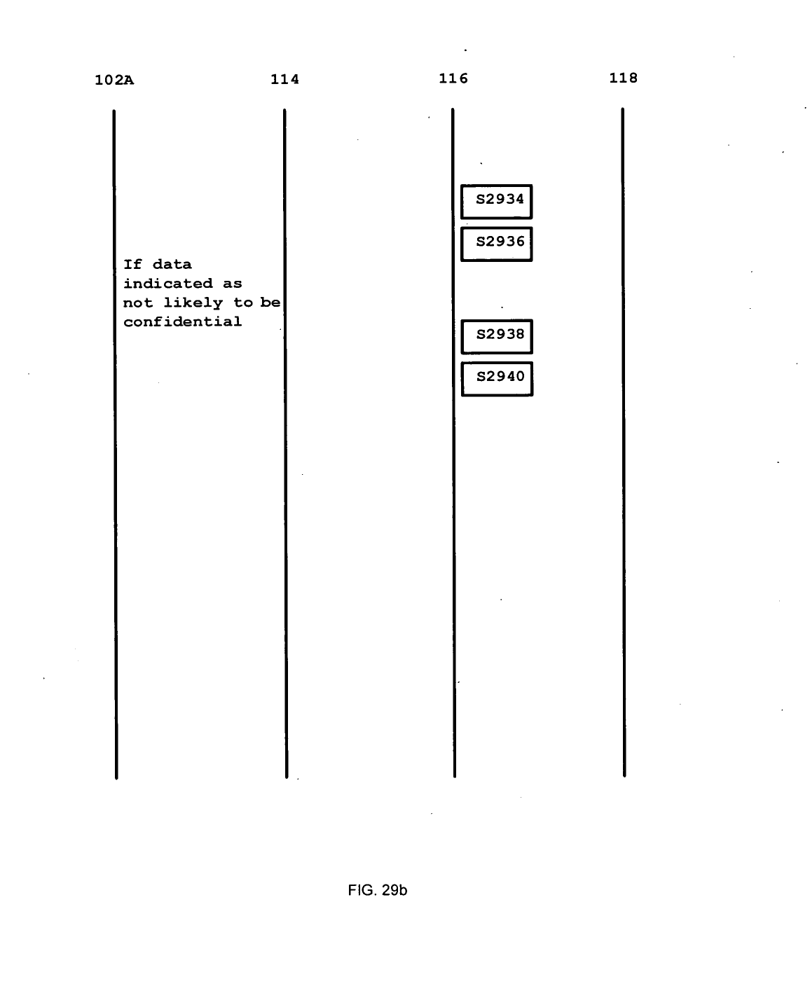

FIGS. 29a and 29b are process flow diagrams illustrating how the system acts to trace the sharing of an item that is stored on the data store in accordance with an embodiment of the present invention.

### DESCRIPTION

An overview of a system comprising an apparatus in accordance with an embodiment of the present invention will now be described with reference to FIGS. 1a and 1b.

An overview of the system 100 is illustrated in FIG. 1a. The system comprises a first computer 102A, a second computer 102B, a cluster of servers 104, an item store 106 and a communications provider 122. The first computer 102A and second computer 102B are configured to communicate with the cluster of servers 104 and the item store 106 using the internet and/or another communications medium.

The first and second computers 102A and 102B each comprise a processor 108A and 108B which is operative to execute program code to configure the processors to implement an application program 110A and 110B. The computer 102 may, for example, be a mobile computing device such as a smartphone, a tablet or a laptop computer, or a desktop computer. Any other type of computing device that can communicate with the cluster of servers 104 may also be used. The computer will generally communicate wirelessly with the cluster of servers 104 but other types of communications medium such as, for example, fibre optic or twisted-pair copper wire, may be used without stepping outside of the scope of the subject matter disclosed herein.

The application programs 110A and 110B comprise routines which, when executed on the first and second computers 102A and 102B, provide an interface through which output may be provided to a user and a user can enter input to system 100.

The architecture of cluster of servers 104 is schematically illustrated in Figure lb and comprises a web server 114 operative to communicate with the web interface 112 to receive requests from the first and second computers 102A and 102B, an application server 116 operative to execute instructions responsive to requests from the web server 114 and to call a library of Application Program Interfaces (APIs) through API interface 120, and a database server 118 including a Database Management System (DBS) 136 operative to control the organisation, storage, retrieval, security and integrity of the data in a database 134. The DBS 136 is further operative to edit and store data in the database 134 responsive to a request from the application server 116. The application server 116 and the database server 118 are each operative to retrieve data from storage 140. Database server 118 also comprises a database interface 138 for communicating between the database server 118 and application server 116, for example. Data storage 140 include data stored as part of data base 134, i.e. a relational database, and also data structured in flat file format accessed directly by application server 116.

Although FIG. 1b illustrates storage 140 within the cluster of servers 104, storage 140 may reside outside the cluster of servers and/or be a part of any one or other of the servers comprising the cluster of servers 104.

The application server 116 is operative to respond to requests from the web server 114 and the database server 118 via an application interface 132. The application server 116 comprises a processor 150 operative to execute instructions for a plurality of modules which each relate to an aspect of the functionality of the application programs 110A and 110B. The application server 116 is operative to call upon an API library through API interface 120 comprising a collection of APIs to enable requests to be made to a communications server 122 and to a data store 106. The API interface 120 forms a communications layer between the cluster of servers 104 and third parties that provide data to the system 100 illustrated in FIG. 1a.

The web server 114 is operative to configure and deliver content to computers 102 in the form of dynamically generated web documents for display at the first computer 102A and/or the second computer 102B. The web documents may comprise user input regions operative to receive user input at the computer 102 and may also comprise text output. The web documents may also comprise multiple frames to accommodate frames corresponding to different content sources within the document such as documents and images. Some of the web documents may be stored in template form in the store 140. The template of a web document may include text fields and input regions to be configured by the web server. In the described embodiment the web documents are dynamically generated using server side scripting in the application server 116 using calls to the database server 118 for the information that is to be used in the web document.

The database server 118 is operative to execute instructions for routines forming the database management system (DBS) 136 for a database 134. The DBS 136 is operative to control the organisation, storage, retrieval, security and integrity of the data in the database 134. The DBS 136 is further operative to edit and store data in the database 134 responsive to a request from the application server 116.

The data store 106 is operative to receive a request from the cluster of servers 104 either using an API 128 or with a direct response to the cluster of servers 104. The data store 106 comprises storage 124 where the item is stored. The API 128 of data store 106 may provide access to a number of data store 106 services for managing data stored in the data store 106, controlling access thereto and communicating requests and data between the data store 106 and a requesting API, such as an API 120 of the cluster of servers 104. The data store, responsive to receiving the request from the cluster of servers 104, is operative to respond to the request using an API 128 for communications with the cluster of servers.

The communications provider 122 is operative to receive a request from the API of cluster of servers 104 and to generate a communication in response to receiving that request, record details concerning the communication and transmit those details back to the cluster of servers 104. The communications provider 122 may provide, for example, email services, telephone services or instant messaging services.

### Registration

In the described embodiment, prior to using the system 100, a user registers on the system to establish a presence in the system. The process of registration is described using the process flow control diagram in FIG. 2.

Initially, a user establishes a presence in the system 100 by registering on the database 134 through DBS 136. A user registering on the system establishes communication with the cluster of servers 104 and transmits their user data to the cluster of servers. The new user establishes communication with the server using a user interface 200 displayed on the first computer 102A as illustrated in FIG. 3. The user interface may be generated by a web browser running on the first computer 102A or the application 110A which may be downloaded from a generic application store, step S200.

The user enters their email address into input region 202, their password into input region 204 and confirmation of their password into input region 206 and then selects a user selectable link entitled “SUBMIT” to submit the information entered into input regions 202 to 206. The data is then transmitted to the web server 114 where it is received at the web interface 112, step S202.

The data transmitted to the cluster of servers 104 from the first computer 102A may additionally comprise further user metadata such as telephone and street address contact details for the user, details regarding the organisation to which they belong (if any) and an indication of a membership of any group of users of system 100 the may belong to.

Responsive to receiving the data from the user computer 102A the web server 114 transmits a request to the database server 118 via the application server 116, step S204, for the DBS 136 to interrogate the database 134 for a registered user with an email address corresponding to the email address input into input region 202. The DBS 136 queries the database 134 for a registered user with the email address entered into input region 202, step S206.

If the DBS 136 reports a match, the database server 118, step S208 issues a request to the application server to request input of an alternative email address. Responsive to receiving the request in step S208, the processor 150 in the application server formulates a request to be sent to the user to input a different email address or to reset the password to use the address currently in the database, step S210.

The request to input an alternative email address is sent to web server 114, step S212. Responsive to receiving the request from the application server 116 in step S212, the web server 114 configures a webpage comprising text and input fields setting out the request and providing a response region, step S214 and communicates the request webpage to the user computer 102A, step S216.

The user computer 102A displays the web page and receives a response from the user comprising either a new email address or a request to reset the password, step S218. The response is communicated back to the web server 114, step S220, where it is determined, step S222, if the response comprises a new email address or a request to reset the password for the matched email address. If the response comprises a new email address the new email address is communicated to the database server 118, step S223, where the process flow returns to step S206 and the procedure for checking the availability of the email address is resumed.

If the response comprises a request to reset the password for the matched email address the password is reset using a temporary one time password token and self-service password reset routine, step S224, and the new password is communicated to the database server 118, step S226, and the relevant user record 1104, illustrated in FIG. 11, updated with the new password, step S228. If the DBS 136 returns a report responsive to the interrogation of the database 134 which says that the email address, whether the first one provided or an alternative, is not already in use, step S206, the email address is temporarily assigned to that user and the DBS 136 instantiates a user record 1104 in the database 134, step S234. The user record 1104 comprises at least a user identity attribute allocated by system 100 (typically allocated on a sequential basis in order of user registration in the system 100) and a password attribute which is populated respectively by the email address and the password transmitted to the web server in step S202. The user record may further comprise fields related to the metadata transmitted in step S202 which are then populated by that metadata.

Responsive to the instantiation of the user data structure in step S234, the database server issues a request to the application server for the user to be validated on the system, step S236.

If the user has indicated they are a member of a group of users of the system 100, a field 1122 may be added to the user record 1104 to indicate which group the user belongs to. Responsive to receiving the indication of group membership the web server 114 issues a request to the application server 116 for confirmation that the user should be added to that group of users in a step S238. Responsive to receiving this request, the application server 116 sends a message via the web server 114 to the other members of the group and/or to a designated group administrator to confirm that the user is a member of that group in step S240.

Responsive to receiving confirmation, a request is made to the application server 116 for the user to be added to that group. All groups are comprised in a Group Table 1130 in a relational database structure which will be described later with reference to FIG. 11.

Steps S238 and S240 are repeated for each of the groups indicated by the user.

The group data structure 1130 comprises a group data structure ID 1130a, a group data structure name 1130b which is used to identify the group, a list of the members of the group 1130c, a list of restricted activities 1130d and a list of flagged activities 1130e comprising workflows and activities within workflows that the group assigned to the data structure cannot be involved with. For example, a group belonging to a human resources team in an organisation may be restricted from sharing documents from the third party data store 106 with individuals outside of the human resources team, i.e. the group. In another example, a team of legal practitioners may only be permitted to share documents from the file store 106 with a specific list of parties.

### Validation on the System

The validation of a user on the system is now described with reference to FIG. 4.

Responsive to receiving the request to validate the user in step S236, the application server 116 issues instructions to a validation module, step S400, the validation module executes a routine to generate a validation code, step S402.

The validation code is transmitted to the web server 114 from the application server 116 with a request that the validation code is included in a validation document to be sent from the web server 114 to the computer 102, step S404. Responsive to receiving the request from the application server 116 the web server 114 responds with a request for a validation document and application server 116 retrieves a validation document from storage 140, step S406 and transmits the validation document to the first computer 102A including the validation code, step S408. Responsive to receiving the validation document in step S408, the processor 108A instructs the application program 110A to display the validation document in a user interface with the validation code, step S410.

The validation document may contain a selectable link which, responsive to user selection thereof, causes the first computer 102A to transmit a request to the web server 114 for validation of the user, step S412. Responsive to receiving the validation code in step S412, the web server 105 then requests confirmation of the correct validation code from the application server 116 via the application interface 132 in step S414. The processor 150 in the application server 116 then instructs the validation module to compare the validation code received from the web server 114 with the validation code that was transmitted to the web server 114, step S416. If the validation code received from the web server 114 matches the validation code transmitted with the web document the validation of the user is confirmed. The application server 116 then transmits a request to the web server 114 to configure a confirmation document, step S418. The web server retrieves the confirmation document from the store of web documents 130 then transmits the confirmation document to the computer 102 confirming the user's presence in the system, step S419.

If the comparison in step S416 reveals that the validation code generated by the validation module in step S402 is not identical to the validation code received in step S412 the application server 116 issues a request, step S420 to the web server 114 to transmit to the first computer 102A, step S421 a series of instructions which, when displayed on the first computer 102A, informs the user that the validation code is not correct and that access to the system is denied. Optionally or additionally, the application server 116 may then transmit a request to the database server 118, step 422 requesting that the user data structure instantiated in step S234 is deleted. Responsive to this request being received at the web server 114, the DBS 136 deletes the user data structure generated in step S234.

Optionally or additionally, the user may confirm that the email address entered by them into the system is their own by receiving an email which they have to respond too. That email may contain a unique alphanumeric code to be input to a web page or a URL which when pressed validates that email address as authentic and that of the user. Such an optional or additional procedure allows third parties and/or other methods e.g API, sms, email, social networking and/or twitter to be used. Consequently, it is beneficial if the default provides for the use of email as the unique identifier for the system.

### Accessing the System

The authentication of a user in the system 100 will now be described with reference to FIGS. 5a and 5b.

In a first step S500 the user loads the application 110A onto first computer 102A which causes the computer to issue a request, step S502 to the web server 114 via the web interface 112 for a main user page which presents the user with a selection of data stores where they have stored an item they would like to enable another person to access.

The web server 114 responds to the request in step S502 with an access document that is transmitted to the first computer 102A, step S504 via the web interface 112. The access document is retrieved from local store 130. Responsive to receiving the access document the processor 108A at the first computer 102A executes instructions to instruct the display on the first computer 102A to display the access document as a user interface 600, step S506 displaying a plurality of selectable links 602A to C which, responsive to user selection, confirm a selection of a third party data store 106 where an item is stored.

An example of the user interface 600 is illustrated in FIG. 6.

Responsive to user selection of one of the selectable links the first computer 102A transmits a request to the web server 114 via the web interface 112, step S508 for access to the data store 106 corresponding to the selected selectable link. Responsive to receiving the request in step S508, the web server 114 transmits a request to the application server 116 via the application interface 132, step S510 for access to the selected third party data store 106.

Responsive to receiving the request in step S510, the application server calls a data store API from the library of APIs through API interface 120 corresponding to the third party data store 106, step S512, to issue a request to the third party data store 106 for an access token 1116 that can be stored in the user record 1104.

The request is then transmitted to the third party data store 106, step S514. The third party data store 106, responsive to receiving the request in step S514, calls an API 128 to access the cluster of servers to provide a request token to the application server 116 with a request for the user credentials which the user uses to access the third party data store 106, step S516. The request prepared in step S516 contains the third part data store request token and is transmitted to the application server 116, step S518. Responsive to receiving the request in step S518, the application server 116 calls the data store authentication API from the library of APIs through API interface 120, step S520 with a request for the user to be directed to the third party data store 106, step S522. The request token is used as input to the authentication API and the request is then transmitted to the third party data store 106, step S524.

Responsive to receiving the request in step S524, the third party data store 106 issues a request for the user's authorisation credentials to the first computer 102, step S526. The request in step S526 comprises a document containing user input regions relating to the email address that the user registered when they registered with the third party data store 106 and the password that are used to authenticate the user on the third party data store 106. Responsive to receiving the document in step S526, the processor 108A at the first computer 102A executes instructions to display the document received in step S526 as a user interface 700 operative to receive the user's authentication details, step S528.

An example of user interface 700 is illustrated in FIG. 7.

The user interface 700 in FIG. 7 comprises a first user input region 702 where the email address is input and a second user input region 704 where the user password is input. The user interface 700 further comprises a selectable link “Confirm”706.

The user then enters their email address into input region 702 and their password into input region 704. Responsive to the user selecting the selectable link “Confirm” 706 a request is transmitted from The first computer 102A to the third party data store 106 containing the email address and the password that were entered into user input regions 702 and 704, step S530.

Responsive to receiving the request from the first computer 102A in step S530, the third party data store 106 checks in step S532 the email address and password to ascertain whether they correspond with the user details that are registered with the third party data store 106. If the email address and password do correspond to the correct user details, then access is confirmed by third party data store 106, step S534, by transmitting a confirmation document to the first computer 102A, step S536. The confirmation document is retrieved from the data store 140. If the email address and password do not correspond to the correct user details, access is denied and steps S524 to S530 are repeated until the correct email address and password are input into user interface 700.

Responsive to the data store 106 initiating transmitting a confirmation document to the computer 102 in step S536, the third party data store 106 calls the API through API interface 120 to issue a request to the application server 116 confirming the user authentication on the third party data store 106, step S538, and requesting that the user is given access to the third party data store 106.

The request in step S538 uses the request token transmitted to the cluster of servers in step S518 and a verifier value, typically a flag value, confirming the authentication of the user on the third party data store 106.

Responsive to receiving the request in step S538, the application server 116 calls an access token API from the library of APIs through API interface 120 in step S540 to request the access token 1116 that will enable the cluster of servers 104 to access the third party data store 106 on behalf of the user. The request is transmitted to the third party data store 106, step S542. Responsive to receiving the request in step S542, the third party data store 106 performs a validation check on the request containing the verifier flag and the request token, step S544.

Responsive to receiving the request for the access token in step S542, the third party data store 106 responds to the request by calling the API 128 to issue an access token, step S546 which is then transmitted to the application server 116. Responsive to receiving the access token in step S546, the application server 116 transmits a request to the database server 118 for the access token 1116 to be stored in the user record 1104, step S548. Responsive to receiving the request in step S548, the DBS stores the access token 1116 in the database, step S550 and then responds to the request in step S548 with a confirmation which is transmitted to the web server 114, step S551. The web server 114, responsive to receiving the confirmation in step S551, issues a “proceed further” request to the computer 102A, step S552. The proceed further request comprises a web document retrieved from the web document store 130 or dynamically generated which responsive to being received by the computer 102A, is displayed on the computer 102A as a user interface 800, illustrated in FIG. 8, with a selectable link 802 and a text box 804 which informs the user that access to the third party data store 106 has been enabled. Once the access token 1116 has been stored in a user record 1104 for a particular user the access procedure described above does not need to be repeated for that user unless their access credentials to the third party data sore 106 change or are lost, corrupted or otherwise becomes no longer available.

OAUTH (see RFC 5849—OAUTH) is an example of an authorisation protocol using access token exchange which may be used in the above for secure delegated access.

Referring to the user interface 800, actuation of the selectable link 802 initiates the next phase of operation comprising sharing of an item stored on the third party data store 106. For the avoidance of doubt, the term “sharing” may be construed broadly to include activities which involve entities other than the user having access to the item and includes without limitation collaborative activities, editing, modifying and reading for example. Such activities are generically described as “workflows” which operate on one or more items.

Optionally, or additionally, access tokens may be stored for more than one third party data store 106 in accordance with steps S506 to S552.

Following storage of one or more access tokens in accordance with steps S506 to S552, as mentioned earlier, the user may use the system repeatedly without the need for this process to be repeated.

### Sharing an Item

The user's presence in the system and the presence of the access token 1116 in the user record 1104 mean that the user can now use the cluster of servers 104 to invite other parties to access the items they have stored on the third party data store 106. The following section will describe how a share is set up.

The user inviting another party to access an item will now be described with reference to FIG. 9.

Responsive to selecting to proceed further on the user interface 800, a request is transmitted from the first computer 102A to the web server 114 via the web interface 112, step S900 for a workflow to be initiated with another party. Responsive to receiving the request in step S900, the web server 114, step S902 issues a request to the application server 116 via the application interface 132 for available workflows and associated items that may be initiated with other parties.

Responsive to receiving the request in step S902 the application server 116 issues a request to the database server 118 via the database interface 138 for any workflow restrictions that may exist for the user, step S904. Responsive to receiving the request in step S904, the DBS 136 queries database 134 for workflow restrictions that are recorded in the user record 1104, step S906. Workflow restrictions may be on the amount of data that may be used in a single workflow or that certain types of workflow are restricted or that particular types of items cannot be shared. The user record may contain fields corresponding to restrictions on the amount of data generated by a single workflow or restricted workflows. In the described embodiment, FIG. 11 illustrates Restriction 1 points to a restricted DNS Table 1128 comprising DNS identities and user IDs which are not to access the DNS. If the user ID is linked to a DNS in the DNS Table 1128 then the user is not permitted to share with an entity using that DNS. Other restrictions may exist, such as a restriction on certain telephone numbers and a telephone Number Table 1129 may be interrogated.

If the user is a member of a group, i.e. field 1122 of user data structure 1104 populated with one or more User Group IDs, the DBS queries the group data structure 1130a stored in Group Table 1130 corresponding to each User Group ID in field 1122, to ascertain the presence of restrictions on the workflow or the item that is to be shared. In the interests of clarity, the description will now will proceed on the basis that no such restrictions exist but potential restrictions and their application will be described later.

Responsive to the query in step S906 the DBS 136 returns a positive result, step S908, indicating that no restrictions exist. The database server 118 responds to the request in step S904 with a positive confirmation to the application server 116, step S910. The application server 116 then responds to the request in step S902 by sending to the web server 114 a list of possible workflows to be provided to the user, step S912. Responsive to receiving the list in step S912, the web server 114 retrieves a workflow initiation document from web document store 130 and populates the workflow initiation document with the list of possible workflows, step S914. The workflow initiation document is transmitted to the computer 102 with a request for a workflow to be indicated, step S916.

Responsive to receiving the workflow initiation document in step S916, the processor 108A at the first computer 102A executes instructions to display the workflow initiation document as a user interface 1000 comprising a plurality of selectable links each corresponding to a workflow that may be initiated, step S918.

An example of the user interface 1000 is illustrated in FIG. 10.

The workflows correspond to selectable links 1004 A to I “1. New/Amend Relationships”; “2. Buy/Sell”; “3. Share”; “4. Collaborate”; “5. Invite”; “6. Offer”; “7. Negotiate”; “8. Hybrid”; and “9. Bespoke”.

The user may select a selectable link 1004 on the user interface 1000 corresponding to the workflow they would like to initiate and select confirm on the selectable link 1002. Responsive to the user selecting confirm on the selectable link, a request for a workflow to be initiated corresponding to the selected workflow is transmitted to the web server 114, step S920.

The request in step S920 is received by the web server 114 via the web interface 112. Responsive to receiving the request in step S920, the web server 114, step S922, issues a request to the application server 116 via application interface 132 for the selected workflow to be initiated.

In the following example, the user has selected “4. Collaborate”.

Responsive to receiving the request in step S922, the application server 116, step S924, accesses storage 140 for details of the minimum workflow requirements that are associated with a collaborative workflow such as the one selected by the user. Storage 140 stores details of the available workflows.

The minimum workflow requirements may relate to the likely amount of data that is to be used or the possibility that more than one party may be invited to collaborate. In this example, where the user has indicated they would like to initiate a collaborative workflow, the storage 140 contains the data value corresponding to an amount of data that is likely to be required by the cluster of servers 104 to complete the workflow and also a flag indicating it is likely more than one person could be invited to collaborate. The application server 116 can assess the likelihood of more than one person in the collaboration by executing a routine which: reviews the user's previous activities to determine the number of users in a collaboration previously; reviews the group membership of the user to see if a large number of people are in the group; or the likelihood can be configured by the user who may log into the system to change their user record to indicate that they may wish to collaborate with a large number of people.

The application server 116 then issues a request to the database server 118 for a “Collaborate” workflow to be initiated, step S926. Responsive to receiving the request in step S926, the database server 118 instructs the DBS 136 to instantiate a workflow data structure 1102 in the database 134, step S928.

The workflow data structure 1102 is related to the user record 1104 in a relational database structure 1100 as illustrated schematically in FIG. 11 which is indexed by a workflow data structure identification number generated by the application server 116.

The workflow data structure 1102 comprises fields relating to the email address 1108, the name of the at least one entity with which the user is collaborating 1118, the time the workflow data structure was instantiated 1110, the date that the workflow was instantiated 1112 and the type of workflow that has been instantiated 1114, in the described instance a collaboration workflow.

How an item is selected for the collaboration will now be described with reference to FIG. 12.

Responsive to the workflow data structure 1102 being instantiated, the database server 118 issues a confirmation to the application server 116, step S1200. Responsive to receiving the confirmation in step S1200 the application server 116 calls an item access API from the API library through API interface 120, step S1202, so a request for access to the items the user has stored on the third party data store 106 can be issued to the third party data store 106. The request requires the access token 1116 issued in step S546 as input.

The application server 116 then issues the request to the data store, step S1204.

Responsive to receiving the request in step S1204 the third party data store 106, after checking the access token corresponds to the access token issued to the cluster of servers 104, step S1206, transmits an item list document to the application server 116, step S1208.

The item list document comprises a list of uniform resource locators (URLs) or links. Each URL corresponds to an item the user has stored on the third party data store 106. The transmission of the item list document in step S1206 also includes the transmission of information concerning the preferences of the user in the third party data store 106. These preferences may include presentational preferences relating to how the items are displayed. Additionally, the preferences may also include constraint information constraining some of the items in the list from being selected for collaboration.

The item access API can access the third party data store 106 but does not access the content corresponding to the items. The item access API can alter the permissions that are attached to the data items.

Responsive to receiving the item list document in step S1208, the application server 116 transmits the item list document to the web server 114, step S1210. Responsive to receiving the item list document in step S1210, the web server 114 transmits the item list document to the first computer 102A with a set of indices applied to the URLs and a request for a choice of item or items that the user would like to be the subject of the collaboration workflow, step S1212. Each index in the set of indices can be used to index the corresponding workflow data structure 1102 if the item having that index is selected for the collaboration workflow.

Responsive to the first computer 102A receiving the item list document in step S1212, the application 110A instructs the processor 108A to display the item list document as a user interface 1300, step S1214.

An example of user interface 1300 is illustrated in FIG. 13.

Each item is displayed with its URL 1302 and a tick box 1304 by its side where the user can indicate a preference for that item. A selectable link entitled “Confirm” 1306 is also displayed.

Optionally, each item may be displayed visually as a thumbnail or another visual or pictorial representation dependent upon the presentational preferences that are transmitted in step S1206, or some other indicia.

The user selects which item they would like to be the subject of collaboration, i.e shared, by selecting the appropriate tick box 1304 and then selecting “Confirm”. Again, using the example of a group of users corresponding to a human resources team, if the user is part of such a group, the user interface 1300 may also contain a tickbox to validate the data contained in the item to be shared. In the example of a human resources team, this may be a tickbox to validate that the item to be shared does not contain confidential data relating to employees of the organisation to which they belong.

Responsive to the user selecting “Confirm”, the computer transmits a request to the web server 114 via the web interface 112, step S1216. The request includes the index or indices indicating which of the tick boxes has been ticked. For clarity of description, in the described embodiment only one box has been ticked and one index included in the request. Responsive to receiving the request in step S1216, the web server 114 issues a confirmation to the application server 116 via the application interface 132 with the index corresponding to the tick box that has been ticked, step S1218. Responsive to receiving the index in step S1218, the application server 116 matches the index with the URL of the corresponding item with one of the URLs stored in third party data storage 106, step S1220, retrieves the corresponding URL and forwards the URL to an encryption module to be encrypted.

Using an example URL the encryption process used by the encryption module we will now described. Take the example URL:

“http://drive.google.com/a/sharewell.co.uk/file/d/0B0gwz7czMOMzOTB5LTA2eXJ0eXciedit?usp=sharing”

This URL is fed as input by the application server into the module where it is received as a string of characters. The URL is then separated into its component parts: the protocol, i.e. https://, the domain, i.e. drive.google.com/, the folder, i.e. a/sharewell.co.uk/, the unique elements, i.e. file/d/0B0gwz7czMOMzOTB5LTA2Exj0ExC/EDIT?usp=sharing”.

Each of the component parts of the URL are encrypted separately using an encryption algorithm, typically based on symmetric or public key encryption to produce encrypted component parts. It will be evident to the person of ordinary skill in the art that encryption of the separate components is merely an optional approach and the URL as a whole may be encrypted. Encryption protects the identity of both the source and destination of data as well as users associated with it.

The application server issues a request to the database server 118 via the database interface 138 for the encrypted component parts of the URL to be stored in a corresponding field, 1115, in the workflow data structure 1102, step S1222. Responsive to receiving the request in step S1222, the DBS 136 stores the URL in the corresponding field, 1115, in the workflow data structure 1102 stored in database 134, step S1224, and issues a confirmation to the application server 116 via the application interface 132, step S1226. The encrypted URL is identified by the workflow data structure ID 1106 of the structure is in which it is stored and through that to a user via the email address field 1108 in the workflow data structure 1106.

The remaining URLs in the item list document are not stored after a URL has been selected so that they do not remain in the system thereby protecting their identity.

Optionally or additionally, multiple items may be selected to be shared in accordance with steps S1200 to S1226. Each item may be from a different data store. The system 100 may therefore enable the user to manage a complex workflow arrangement involving multiple items through a single interface. The system 100 therefore enables the time-consuming management of such a complex workflow arrangement in an efficient manner as one interface can be used to manage a workflow involving many items.

Responsive to receiving the confirmation in step S1226, the application server 116 issues a request to the web server 114 for an entity with whom the user would like to collaborate, step S1228.

The selection of the entity will now be described with reference to FIGS. 14a and 14b.

Responsive to receiving the request in step S1226, the application server 116 retrieves an invite document from storage 140, step S1400. The invite document is transmitted to the first computer 102A with a request for details of the entity with whom the user would like to collaborate, step S1402. Responsive to receiving the invite document at the first computer 102A, the application 110A instructs the processor 108A to display the invite document as a user interface 1500, step S1404.

An example of user interface 1500 is illustrated in FIG. 15.

User interface 1500 comprises input region 1502 for the address of the entity with which the user would like to collaborate, input region 1504 for the subject the user would like to give to the collaboration. User interface 1500 also comprises a selectable link entitled “Send” 1506.

Typically, the address corresponds to the email address of an individual but may also be a telephone number or an online system API corresponding to a social networking site, for example.

The user enters the email address of the entity into input region 1502 and the subject in 1504 and selects the selectable link 1506. Responsive to the user selecting the selectable link, the first computer 102A issues a request to the web server 114 via the web interface 112 for a collaboration to be established with the entity entered into input region 1502, step S1406.

The user interface 1500 may also provide a pick list comprising a list of contacts from the user's computer 102A. The user may select from the pick list the entity with which they would like to collaborate.

Responsive to receiving the request in step S1406, the web server 112 transmits a request to the application server 116 for a collaboration workflow to be established with the entity entered into input region 1502, step S1408. The application server 116 calls a restricted email API from the library of APIs through API interface 120 for an internal or external data store containing restricted email addresses in a step S1410. The external data store could be an email blacklist such as SPAMCOP which acquires IP addresses and DNS servers reported to be the source of SPAM. Following the call to the restricted email API a request is issued to an external data store to be queried in relation to the email address entered into input region 1502, step S1412. Other blacklisted data may include, IP addresses, DNS servers, domains and telephone numbers

The query can return one of two outcomes: a positive outcome and a negative outcome. A positive outcome occurs when the email address is not a restricted email address and a negative outcome occurs when the email address is a restricted email address.

The external data store returns the positive outcome or the negative outcome responsive to the query in step S1412 and transmits the outcome back to the application server 116, step S1414. The outcome is transmitted as a binary flag value where the first possible value corresponds to a positive outcome and the second possible value corresponds to a negative outcome.

Typically, a restriction is predicated on a history of phishing or malware being sent from a domain name server (DNS) underpinning the email facility to which the restricted address is attached. If the DNS has been recorded as sending substantial amounts of phishing software or malware then it will draw the attention of an email blacklist which may be stored on an external data store such as the one described herein. A history of phishing or malware can be built up by users reporting a server as the source of such activity.

Additionally, a user may upload to the user record a list of DNS servers, domain names and email addresses to a DNS Table 1128 that they may wish to restrict access to. The DNS a particular user wishes to restrict access to is associated in the DNS Table 1128 with the userid. Such a list may be related to the user record 1102 in the relational database structure 1100 illustrated in FIG. 11 through the relevant restriction field. The DNS servers may be servers that are the source of abuse of the IT facilities that sit within the organisation to which they belong. Such abuses may take the form of simple mail transfer protocol (SMTP) session hijacking, transmitting operating system bugs into a hosting system, denial of service attacks, email bombs and copious spamming.

However, the external data store would typically categorise the threat posed by restricted email addresses which enables an assessment to be made of the threat level posed to the user.

Responsive to the flag value transmitted in step S1414 corresponding to the negative output, the application server 116 responds to the communication of the flag value in S1414 with a query to the external data store for an analysis of the threat posed by the DNS server related to the restricted email address, step S1416. Responsive to receiving the query, the external data store responds with a categorisation of the threat posed by the respective DNS server, step S1418. For example, a Genetic Programming method of analysis or alternatively a Binomial or Monte Carlo method may be utilised.

If the categorisation received in step S1418 categorises the threat as being high, the application server 116 issues a request to the database server 118 to establish whether the respective DNS server is on a restricted list of DNS servers that the user has uploaded previously, step S1420. Responsive to receiving the request in step S1420, the DBS 136 interrogates the list of restricted DNS Table 1128 to see if the DNS is on the list, step S1422.

If the DNS is on the list then the DBS 136 issues a confirmation back to the application server 116 that the DNS is restricted, step S1424. Responsive to receiving the confirmation in step S1424 the application server 116, step S1426, transmits a request to the database server 118 for an email address rejection document, which is retrieved from storage 140, step S1428, to be sent to the first computer 102A, step S1430.

The email address rejection document comprises a text region informing the user at first computer 102A that the address received by the cluster of servers 104 in step S1406 is restricted. The email address rejection document also provides a user input region into which the user can enter an alternative email address. In the event the user enters another email address, the steps S1406 to S1422 are reiterated until an unrestricted email address is entered or the user stops the process.

If the domain name is not on the list then the DBS 136 adds the domain name to the DNS Table 1128 as a high risk domain name, step S1432. The DBS 136 then issues a confirmation back to the application server 112 that the domain name has been added to the list of high risk domain name servers in DNS Table 1128, step S1434. Responsive to receiving the confirmation in step S1434 the application server 116 transmits a request to the web server 114 for the email address rejection document to be sent to the computer 102, step S1436 albeit with a modification to say that the address received by the cluster of servers 104 in step S1406 is served by a domain name that has been restricted as it has been blacklisted The web server 114 responds to the request from the application server 116 by issuing the modified email address rejection document to the first computer 102A, step S1438. In the event the user enters another email address, the steps S1406 to S1422 are reiterated until an unrestricted email address is entered.

Optionally or additionally, the DBS 136 may, prior to adding the domain name to the DNS Table 1128 as a high risk domain name in step S1432, query a user permissions field in the user record to check whether the user can override the list of high risk domain name servers in DNS Table 1128 and, if the user can override the list of high risk domain name servers, prompt the user to query whether the list of high risk domain name servers can be overridden. The user permissions field may set out that the user cannot share with particular parties or that the user cannot share particular files with particular parties. Those parties may have a history of hostility towards the user or may be known for generating malware or phishing attacks.

If the categorisation received in step S1422 categorises the threat as being low, the application server 116 issues a request to the database server 118 to establish whether the domain name is on the list of restricted domain names in DNS Table 1128, step S1438. Responsive to receiving the request in step S1438, the DBS 136 interrogates the list of restricted domain names in DNS Table 1128 to see if the domain name is on the list, step S1440. If the domain name is on the list then the DBS 136 issues a confirmation back to the application server 116 that the domain name is restricted, step S1442. Responsive to receiving the confirmation in step S1442 the application server 116 transmits a request to the web server, step S1444 for the email address rejection document to be sent to the first computer 102A. Responsive to receiving the request, the email address rejection document is transmitted to the first computer 102A, step S1446. In the event the user enters another email address, the steps S1406 to S1422 are reiterated until an unrestricted email address is entered.

If the DBS 136 interrogates the list in step S1440 and the domain name is not in the DNS Table 1128, the DBS 136 issues an acceptance message to the web server 114 that the domain name is not restricted, step S1448. Responsive to receiving the acceptance message in step S1448, the web server 114 issues a request to the application server 116 to call the database server 118 to instantiate the workflow with the entity entered into the user input region in step S1406, step S1450.

Responsive to receiving the request in step S1450 the DBS 136 in step S1452 populates a corresponding field in the workflow data structure 1102 with the time the user initiated the workflow, i.e. the time that the computer 102 issued the request to the web server 112 in step S1406, and the email address entered into user input region 1502 and received by the web server 112 in step S1406.

Optionally or additionally, the application server 116 may, responsive to the field in the workflow data structure 1102 being populated in step S1450, request details from the database server 118 of any legal agreements or other relationships that exist between the user and the entity with whom the user is looking to collaborate with, step S1454. Such legal relationships may be uploaded to the user record 1104 and may be assigned a risk factor by the application server 116. The user record 1104 may also contain a field to say that a legal agreement or other relationship is necessary for a workflow to take place. In this instance, if an entity is specified in step S1406 with which no legal agreement or other relationship exists, the steps S1400 to S1450 are repeated. Optionally, if no relationship exists a new workflow may be initiated.

Optionally or additionally, the user may add to the user record 1104 content which may be placed into the email to provide the look and feel of the email from an organisation. The content may include legal disclaimers, business information such as company number or a list of directors, contact details for the organisation, marketing material and promotional material. The content may be in the form of URLs or standard text. The content, or at least a pointer to an item containing the content, may be stored in the user record 1104 in a corresponding field.

Optionally or additionally, the user may also add to the user record 1104 a mail gateway which is used to email the user as an alternative to the email address uploaded in step S202. The user may also add to the user record other communications details such as a fax number or a mobile telephone number.

### Initiation of the Workflow

How the item is stored in referenced in the system will now be described with reference to FIG. 16. In general outline, the item is assigned a key in the form of a system unique uniform resource locator that will be transmitted to the other entity in an email from the user and used by the other entity to gain access the item in the third party data store 106. In this regard, the system acts as an intermediate gateway or transaction broker providing a concordance between the unique URL and the encrypted URL. The other entity accesses the system through the web server using the unique URL which is matched to the encrypted URL, the encrypted URL is then decrypted and the system redirects the other entity to the location of the item on the third party data storage defined by the decrypted URL. In the described embodiment at step S1600, the database server 118, responsive to storing the data in the workflow data structure 1102 in step S1452, issues a confirmation to the web server 114 that the workflow parameters have been stored in the various fields of workflow data structure 1102.

Responsive to receiving the confirmation in step S1600 the web server 114 issues a request to the application server 116 for the workflow to be continued, step S1602. Responsive to receiving the request in step S1602, in step S1604 the application server 116 issues a request to the database server 118 via the database interface 138 for the encrypted URL that was stored in the workflow data structure in step S1222. The encrypted URL corresponds to the URL assigned to the item by the third party data store 106. The item will be subject of the collaboration.

Responsive to receiving the request in step S1604, the DBS 136 retrieves the encrypted URL components from the corresponding workflow data structure 1102 in the database 134, step S1606 and the database server transmits the encrypted URL to the application server 116 via the database interface 134, step S1608.

Responsive to receiving the encrypted URL in step S1608, the processor 150 at the application server 116 executes a URL generation module to generate a unique URL which identifies the item, step S1610. The URL generation module comprises a series of instructions which, when executed take the encrypted URL as an input and generate an output which is unique to the entity with which the collaboration is taking place.

The series of instructions forming the URL generation module comprise a generation algorithm. The generation algorithm uses a hashing algorithm to generate a sequence of characters of specific length, 7 characters, say. This is known as a key. Typically a key is generated using a base 36 alphabet using the conventional alphabet a to z and the digits 0 to 9 are used. If there is a need to extend the number of possible keys that may be generated, the key can be generated using a base 62 alphabet which comprises the conventional alphabet a to z, the equivalent capitalisation of those characters (A to Z) and the digits 0 to 9. Generating the key in this way enables a non-predictable key to be generated for each user in each workflow. A unique URL for each user can then be generated by concatenating the key with the domain name of the webserver.

The application server 116, responsive to the generation of the unique URL in step S1610, issues a request to the database server 118 for the unique URL to be stored in the database 134, step S1612. Responsive to receiving the request the DBS 136 stores the unique URL in the workflow data structure 1102, step S1614. A confirmation message is then sent to the application server 116, step S1616 confirming the storage of the unique URL. The workflow data structure is related to tables in the relational database 1100 by the DBS 136.

The effect of generating and storing the unique URL in the workflow data structure 1102 is that the user can control access to the item during the workflow. The user may choose to remove access to the item from the other entity in favour of another entity or indeed, where more than one entity has been invited to collaborate, the generation of a unique URL for each of the collaborating entities will enable individual entities to be restricted from accessing the item if there are, for example, a change of circumstances between the parties or a change in the legal framework which surrounds the document. Control of access to an item in a workflow is simply be deleting or removing a unique URL from the workflow data structure. The entity to which the unique URL is assigned can then no longer access the item of the workflow because the unique URL is no longer active in that workflow data structure.

Indeed, and as will be discussed later, the generation of a unique URL which is used to enable access by another entity to a collaborator, can also be used to prevent access to the item if access to the item is attempted at an internet protocol (IP) address at a particular geographic location or by a party that is known to be attempting to corrupt the item.

The steps S1600 to S1616 may be iterated for multiple items whereby a unique URL may be generated for each item. This enables access to each of the items to be controlled separately.

How the unique URL is transmitted to the entity with which the user would like to engage using the initiated workflow will now be described with reference to FIG. 17.

Responsive to receiving the confirmation in step S1416, the application server 116 calls an API from the API library through API interface 120 to initiate a request to a communications server 122, step S1700. The request is a request to the communications server 122 corresponding to the email address that was received by the cluster of servers 104 in step S202. The request requests that an email to the entity with which the user would like to engage is formulated. The request also contains the unique URL that has been stored in the workflow data structure 1102 and the URL to be inserted into the email.

The communications server 122 may sit within the confines of third party data store 106 or outside of the third party data store 106.

The request is received by the communications server 122, step S1702. The communications server 122 receives the request and issues a response to the request by requesting the authorisation details of the user on the communications server 122.

The communications server 122 issues a request to the user at the first computer 102A for the user to authenticate themselves on the communications server 122 in a step S1704. Responsive to receiving the request, the user at the first computer enters their authentication details which enables them to access the communications server 122 using user interface 1800 as illustrated in FIG. 18.

An example of such a user interface is illustrated in FIG. 18.

The user interface 1800 comprises user input region 1802 operative to receive the email address and user input region 1804 operative to receive the password. The user interface 1800 also comprises a selectable link 1806 entitled “submit”.

Responsive to successful authentication of the user on the communications server 122, the communications server 122 then transmits the response to the request in step S1700 to the application server 116, step S1706.

Responsive to receiving the response in step S1706, the application server 116 issues a confirmation message to the database server 118 to confirm access to the mail server, step S1708.

Responsive to receiving the confirmation message in step S1708, the DBS 136 populates a corresponding field in the workflow data structure 1102, step S1710 and confirms this to the application server 116, step S1712. Responsive to receiving the confirmation in step S1712, the application server 116 calls the email API from the library of APIs through API interface 120 to request that the communications server 122 send the email to the other entity, step S1714.

The request is transmitted to the communications server 122, step S1716 which in turn issues a confirmation message to the application server 116, step S1718. The communications server 122 then sends the email to the entity, step S1720 and issues a confirmation to the application server 116, with a timestamp, step S1722.

The body of the email comprises the unique URL that was given to the item and the entity. If the workflow relates to more than one item, the email contains a unique URL for each of the items that are subject of the workflow.

Responsive to receiving the confirmation, the application server 122 issues a request to the database server 118 for the timestamp to be stored in the workflow data structure 1102, step S1724. Responsive to receiving the request in step S1724, the DBS 136 stores the timestamp in the workflow data structure 1102, step S1726.

Optionally or additionally, the communications server 122 may be provided by a service that also provides the third party data store 106. In this instance, the access token 1116 issued in step S546 can be used to authenticate the user on the communications server 122. The access token 1116 may be accessible from the storage 140, the application server 116 and directly from the third party data store 106.

### Accessing the Item

For clarity, in the following description the user will be referred to as the first user and the entity with whom the user is trying to collaborate will be referred to as the second user.

We will now describe with reference to FIG. 19 how the second user accesses the item. For simplicity of description the second user is taken to be using a second computer 102B. However, it will be understood that the second computer 102B could be a mobile computing device or other computing device with data communications capability.

At the second computer 102B the second user receives an email invite to collaborate on a workflow with the first entity S1900.

An example of an email invite image 2000 displayed on the second computer display screen responsive to the user opening the email is illustrated in FIG. 20.

The email image comprises a text box 2002 indicating the first user's desire to collaborate in relation to an item with the second user. The text box directs the second user to the unique URL 2004 assigned to the item in step S1610. The email also comprises a selectable link 2006 which, when selected, confirms the second user's lack of desire to engage in the workflow with the first user.

Responsive to the second user selecting the link 2006 a request is transmitted to the web server 114 via the web interface 112 for the workflow to be denied, step S1902. The request transmitted to the web server 114 also comprises a timestamp indicating the time at which the second user selected the selectable link 2006.

Responsive to receiving the request in step S1902 to deny collaboration, the web server 114 issues a request to the application server 116, step S1904 for the workflow characterised by the workflow data structure 1102 to be denied. The application server 116 then issues a request to the database server 118 for the workflow characterised by the workflow data structure 1102 to be finished, step S1906. Responsive to the database server 118 receiving this request, the DBS 136 retrieves the workflow data structure 1102 and saves the timestamp received in step S1902, step S1908. The DBS 136 also generates a flag value which is then saved in a corresponding field in the workflow data structure 1102 indicating the workflow has been stopped. The application server 116 also calls the item access API through API interface 120 with a request to alter the permissions in the third party data store 106 in relation to the item to prevent access to the item by the second user.

If the user selects the unique URL 2004 a request is issued to the web server 114 for access to the workflow characterised by workflow data structure 1102, step S1910. Responsive to receiving the request in step S1910, the web server 114 issues a request to the application server 116 via the application interface 132 for the second user to be provided with access to the item corresponding to the unique URL 2004, step S1912.

In response to receipt of the request in step S1912, the web server forwards the unique key from the URL to the database server 118 with a request to lookup the unique key to see if it corresponds to a workflow. The DBS 136 performs a lookup to match the unique key to the workflow. Each workflow corresponds to an ID for the first user “originator ID”, the permissions granted to the second user and the item store 106. If a match is found then a confirmation is sent back to the web server 114, via application server 116, that the workflow exists and it matches the unique key received in step S1912. The access is then logged.

Responsive to receiving the request in step S1912, the application server 116 responds with a request to the web server 114, step S1914 for the second user to be provided with a series of options indicating several choices that the second user may wish to choose from before proceeding with the collaborative workflow to which they have been invited. Responsive to receiving the request in step S1914 the web server 114 retrieves a response document from the storage store 140. The response document comprises a plurality of selectable links indicating the response choices available to the second user at the second computer 102B.

The web server 114 sends the response document to the second computer 102B, step S1916. The processor 108B at the second computer, responsive to the second computer 102B receiving the response document, is operative to cause the response document to be displayed on the display screen of the second computer 102B as a user interface 2100, step S1918.

An example of user interface 2100 is illustrated in FIG. 21.

The user interface 2100 comprises a plurality of selectable links 2102 corresponding to each of the choices available to the second user. The choices are “Accept-Link”, “Reject”, “Request More Time”, “Negotiate”, “Buy” and “Sell”

Responsive to selection of one of the selectable links, a request is transmitted to the web server 114 via the web interface 112, step S1920 corresponding to the choice indicated by selection of that selectable link. The request also comprises a timestamp indicating the time at which the selectable link was selected. In this example the “Accept” selectable link selected.

Responsive to the selection of link 2102, the web server 114 issues a request to the application server 116 via the application interface 132 for acceptance of the workflow, step S1922. Responsive to receiving this request, the application server 116 reviews restrictions that have been requested by the user to check that such restrictions do not apply to the selected workflow or the first or second user, step S1924. The request received by the application server in step S1922 also comprises the timestamp received by the web server in step S1920. The review of restrictions comprises the issuance of a request to the database server 118 via the database interface 138 for an interrogation of the database 134 for restrictions that may be in place, step S1926.

Responsive to receiving the request in step S1926, the DBS 136 interrogates the restrictions data structure 1128 for any restrictions that may apply, step S1928. The application of such restrictions will be described later.

If there are no applicable restrictions, the database server 118 responds to the request in step S1926 with a confirmation that restrictions do not apply to the first or second user or the selected workflow, step S1930. The application server 116 responds to the database server 118 by transmitting the timestamp received in step S1920 with a request for the timestamp to be stored in the workflow data structure 1102, step S1932. Responsive to receiving the request in step S1932, the DBS 136 stores the timestamp in a corresponding field in the workflow data structure 1102 and confirms to the application server 116 via the application interface 132 that the timestamp has been stored, step S1934.

Recording each stage in the workflow in this way enhances the traceability of the workflow as it enables a clear timeline to be established between actions.

Access to the item by the second user at the second computer 102B will now be described with reference to FIG. 22.

Responsive to the confirmation in step S1934, the application server 116 issues a request to the database server 118 for the URL corresponding to the item that is to be accessed, step S2200, i.e. the encrypted URL that was stored in field 1115 of workflow data structure 1102 in step S1222.

The DBS 136 then retrieves the encrypted URL from the workflow data structure 1102, step S2202 and responds to the request in step S2200 by providing the encrypted URL to the application server 116, step S2204. The application server 116, responsive to receiving the encrypted URL from the database server 118, decrypts the URL and utilises the URL in calling an item access API from the library of APIs to issue a request access to the item on the third party data store 106, step S2206, and issues the request, step S2208. In calling the item access API, the application server requests a change to the permissions in the third party data store 106 to enable the item on the data store to be accessed by the second user. The request contains the access token 1116 to enable the third party data store 106 to recognise that access has previously been granted to the third party data store 106, and the URL that was provided by the third party data store 106, for accessing the item.

In some embodiments, a URL may be generated by the third party data store 106 at this stage that is unique to the second user rather than at a preliminary stage before the second user is known to system 100. The URL generation module may be recalled to generate a unique URL for the second user that is based on the generated URL that is generated by the third party data store 106.

The request is received by the third party data store 106 and the item corresponding to the URL is retrieved by the third party data store 106, step S2210. The permissions in the data store are changed to enable the second user to access the item on the third party data store 106. The second user can then access the item on the data store using their own authentication on the third party data store 106.

### Non-Repudiation Log

Application server 116 is configured to record all activity and actions related or concerning the interaction between the first user, the second user and the item for which access has been granted by the first user to the second user. A transaction log may be created by the recording of such activity and actions. Such a transaction may be reviewed to establish the nature of the interactions and what activity was performed on what item by what person with what permissions, for example to repudiate any allegation or lack of clarity concerning the interactions.

### Plural Collaborators

Optionally or additionally, the unique URL may be transmitted to plural second users. The steps set out above are repeated for each user (i.e. the third user, the fourth user, the fifth user etc.) thereby generating a unique URL and workflow data structure in the relational database 1100 for each user.

### Data Restrictions

Optionally or additionally, in step S202 the web server 114 may also receive from the computer 102A an indication from the user that the data they deal with is confidential.

### Restrictions on the Chosen Workflow

If, in step S202, the web server 114 receives an indication that the data the first user shares is confidential, the query in step S906 returns a negative result indicating that restrictions do exist.

How the indication that the first user is intending to share confidential data can influence the generation of a workflow will now be described with reference to FIG. 23.

The description starts from the point where the first user has been provided with access to the third party data store 106 and the user has selected to proceed further to initiate a workflow with the second user.

Responsive to selecting to proceed further, a request is transmitted from the computer 102A to the web server 114 via the web interface 112, step S2300 for a workflow to be initiated with the second user. Responsive to receiving the request in step S2300, the web server 114, step S2302 issues a request to the application server 116 via the application interface 132 for available workflows that may be initiated with the second user.

Responsive to receiving the request in step S2302 the application server 116 issues a request to the database server via the database interface 138 for the workflow restrictions that exist for the user, step S2304. Responsive to receiving the request in step S2304, the DBS 136 queries database 134 for the workflow restrictions that are in the restrictions data structure 1110, step S2306. In this example the restrictions on the workflow are due to the nature of the confidential data that is the subject of the workflow. This means that the DBS 136, on querying the database 134 for the workflow restrictions in the restrictions data structure 1110, returns a result to the application server 116 that some workflows are not permitted as the data that will be subject of the workflow is confidential.

The application server 116 then responds to the request in step S2302 with the list of allowed workflows to be provided to the user that are sent to the web server 114, step S2308. The list of allowed workflows contains “1. New/Amend Relationship”; “2. Share”; “3. Collaborate”; “4. Hybrid”; and “5. Bespoke”. The workflows “Buy/Sell”, “Invite”; “Offer”; and “Negotiate” are removed from the choice of available workflows due to the restriction due to the data being shared being confidential.

Responsive to receiving the list in step S2308, the web server 114 calls the application server for a workflow initiation document which is retrieved from storage 140 which is then populated with the list of possible workflows, step S2310. The workflow initiation document is transmitted through the web server to the first computer 102A with a request for a workflow to be indicated, step S2312.

Responsive to receiving the workflow initiation document in step S2312, the processor 108A at the first computer 102A executes instructions to display the workflow initiation document as a user interface 2400 comprising a plurality of selectable links each corresponding to a workflow that may be initiated, step S2314.

An example of the user interface 2400 is illustrated in FIG. 24. The workflows correspond to “1. New Legal Relationship”; “2. Share”; “3. Collaborate”; “4. Hybrid”; and “5. Bespoke”.

The user may select a selectable link 2404 on the user interface 2400 corresponding to the workflow they would like to initiate and select confirm on the selectable link 2402. Responsive to the user selecting confirm on the selectable link, a request for a workflow to be initiated corresponding to the selected workflow is transmitted to the cluster of servers 104, step S2316.

The request in step S2316 is received by the web server 114 via the web interface 112. Responsive to receiving the request in step S2316, the web server 114, step S2318, issues a request to the application server 116 via application interface 132 for the selected workflow to be initiated.

In this example, the user has selected “2. Share”.

Responsive to receiving the request in step S2318, the application server 116, step S2316, accesses storage 140 for details of the minimum workflow requirements that are associated with a collaborative workflow such as the one selected by the user, i.e. a share workflow. Storage 140 stores details of the available workflows.

The minimum workflow requirements may relate to the likely amount of data that is to be used or the possibility that more than one party may be invited to collaborate. The likely amount of data that is to be used may be assessed by the application server 116 based on the user's previous activity or the size of the item being shared. A user estimation may also be used. In this example, as the first user has indicated that they are sharing confidential data, accessing storage 140 in step S2316 returns the requirement that the workflow cannot allow the data being shared to be shared with any entity outside of a domain specified by the user in the restrictions data structure 1128/1129.

The application server 116 then issues a request to the database server 118 for a “Share” workflow to be initiated, step S2320. Responsive to receiving the request in step S2318, the database server 118 instructs the DBS 136 to instantiate the workflow data structure 1100 in the database 134, step S2322.

The item that is to be shared is selected for the share workflow in accordance with steps S1200 to S1224 as described above.

The selection of the entity with whom the share workflow is to take place will be now described with reference to FIG. 25.

Responsive to receiving the confirmation in step S1224, the application server 116 issues a request to the web server 114 for an entity with whom the user would like to share the item, step S2500.

Responsive to receiving the request in step S2500, the web server 114 requests application server 116 to retrieve an invite document from the storage 140, step S2502. The invite document is transmitted to the first computer 102A with a request for details of the entity with whom the user would like to share, step S2504. Responsive to receiving the invite document at the first computer 102A, the application 110A instructs the processor 108A to display the invite document as a user interface, step S2506. This user interface was illustrated in FIG. 15. User interface 1500 comprises input region 1502 for the address of the entity with which the user would like to share input region 1504 for the subject the user would like to give to the share. User interface 1500 also comprises a selectable link entitled “Send” 1506.

Typically, the address corresponds to the email address of an individual but may also be a telephone number or an online system API corresponding to a social networking site.

The user enters the email address of the entity into input region 1502 and the subject in 1504 and selects the selectable link 1506. Responsive to the user selecting the selectable link, the first computer 102A issues a request to the web server 114 via the web interface 112 for a share to be established with the entity entered into input region 1502, step S2508.

The user interface 1500 may also provide a pick list comprising a list of contacts from the first user's computer 102A. The user may select from the pick list the entity with which they would like to share In this instance, the first user, who uses email server “mail.casterbridge.com”, is inviting the second user who uses email server “mail.longhorn.com”, i.e. a server from a different domain to share the selected item.

Responsive to receiving the request in step S2508, the web server 114 transmits a request to the application server 116 for a share workflow to be established with the second user, step S2510. Responsive to receiving the request in step S2510, the application server 116 issues a request to the database server 118 via the database interface 138 for an indication of restrictions on the mail server of the second user, step S2512. Responsive to receiving the request in step S2512, the DBS 136 interrogates the database 134, step S2513, to ascertain the presence of any restrictions. In addition to the list of domain names indicated previously that set out restricted domain names, the user may also store in the restrictions data structure 1128 conditions on the email address of the second user. As the user has indicated that the data they are sharing is confidential, the restrictions data structure also comprises a condition that restricts any workflow with a second user who uses a mail server that is distinct from the communications server 122 that the first user uses. Therefore, responsive to the request in step S2512, the DBS 136 returns an alert to the application server 116 that the second user cannot be invited into a share workflow as they use a different mail server, step S2514.

Responsive to receiving this alert, the application server 116 issues a request to the web server 114, step S2516 to inform the first user that the email address entered is invalid. The web server 114, responsive to receiving this request in step S2516, issues a request to the application server 116 for a workflow rejection document from the storage 140, step S2517, and issues a request to the first computer 102A by sending the workflow rejection document to the computer 102, step S2518. The workflow rejection document is received by first computer 102A and the application 110A issues instructions to the processor 108A to display the workflow rejection document, step S2520. The workflow rejection document is displayed as a user interface 2600 comprising a text region populated with a text informing the user that their workflow cannot be initiated with the second user and requesting that the first user re-enter the email address of the second user with which they would like to share the item.

An example of the user interface 2600 is illustrated in FIG. 26.

The user interface 2600 comprises an input region 2602 operative to receive an email address and a selectable link 2604 which, when selected, causes the first computer 102 to issue a request to the web server 114 for the share workflow to be initiated with the email address input into input region 2602, step 2522. Responsive to the web server 114 receiving the request in step S2522, steps S2508 to S2520 are repeated until a non-restricted email address is received in step S2508 or the process is stopped.

The item that is to be shared in the workflow is assigned a key in accordance with steps S1600 to S1616. The unique URL is transmitted to the second user in accordance with steps S1700 to S1742 so that the item may be shared with the second user.

### Changing Conditions

Responsive to initiating the workflow, the first user may, as part of the registration process, indicate in step S202 that emails containing the unique URL in accordance with steps S1700 to S1742 are transmitted with terms and conditions attached in addition to the branding corresponding to the organisation to which the first user belongs.

The terms and conditions transmitted with the unique URL in accordance with steps S1700 to S1742 are sometimes important to the legal agreement within which the workflow is to take place. Therefore, it is important to control access to items should any change be made to those terms and conditions.

There will now be described, with reference to FIGS. 27a and 27b, the changing of terms and conditions in an agreement that forms the basis for a workflow.

The user, having a presence in the system, can view all of the workflows they have by inputting a command to the application 110A on the first computer 102A in a step S2700. Responsive to receiving the command in step S2700, the first computer 102A issues a request to the web server 114 via the web interface 112 for the current workflows that the user is involved in a step S2702.

Upon receiving the request in step S2702, the web server 114 issues a request to the application server 116 in a step S2704 for all of the workflows that the user is a part of. Responsive to receiving the request in step S2704, the application server 116 communicates a request to the database server 118 for DBS 136 to retrieve a list of the workflows that the user is involved in a step S2706.

In the relational database structure the user data structure 1104 is related to each of the workflow data structures using the User ID. The user may be involved in a plurality of distinct workflows and the user data structure 1104 may be linked to each of the workflow data structures in a one to many relationship.

The DBS 136 interrogates the relational database 1100 for the workflows that the user is involved in, step S2708. The database server 118 returns to the application server 116 a list of the workflows that the user is involved with, step S2710.

The application server 116, responsive to receiving the list of workflows, dynamically generates a workflow involvement document wherein an index is assigned to each of the workflows, step S2712. The application server 116 then forwards the workflow involvement document to the web server 114 for presentation to the user, step S2714. The web server 114, responsive to receiving the workflow involvement document, transmits the workflow involvement document to the first computer 102 with each of the indices assigned to the workflows, step S2716.

The processor 108A at the first computer 102A, responsive to the workflow involvement document, instructs the display at the first computer 102A to display the workflow involvement document, step S2718. The workflow involvement document may be displayed as a user interface 2800. An example of this user interface is illustrated in FIG. 28a.

The user interface 2800A may comprise a drop down menu displaying each of the workflows that the user is involved with. The user interface 2800A may also comprise a list of user selectable links each corresponding to one of the workflows.

Responsive to user selection of the user selectable link, the computer 102A issues a request to the web server 114 via the web interface 112 for the terms and conditions to be added to the corresponding workflow data structure in a step S2720. Responsive to receiving the request in step S2720, the web interface 114 forwards the request to the application server 116, step S2722.

Responsive to receiving the request in step S2722, the application server 116 issues a request to the database server 118 for the current terms and conditions for the workflow, step S2724. The current terms and conditions are stored in the workflow data structure 1102. The DBS 136 retrieves the terms and conditions from the workflow data structure, step S2726. The terms and conditions also have a timestamp indicating when they were agreed upon.

The DBS 136, having retrieved the terms and conditions from the workflow data structure in step S2726, returns the terms and conditions to the application server 116 in step S2728. The application server 116 uses a validation module to ensure the terms and conditions are correct and that they are up to date by checking the timestamp to see that the terms and conditions are the most recent for that workflow. The application server 116 then forwards them onto the web server 114 in step S2730 as a dynamically generated terms and conditions document.

The web server 114 forwards the terms and conditions document to the first computer 102A in step S2732. Responsive to receiving the terms and conditions document, the application 110A instructs the processor 108A to instruct the display to display the terms and conditions in an editable text region 2802B on a user interface 2800B in step S2734. An example of user interface 2800B is illustrated on FIG. 28B. User interface 2800B comprises a text region where the current terms and conditions are displayed, a selectable link to confirm the amendments 2804B and a selectable link to deny the amendments 2806B.

The user may edit the terms and conditions as they desire before selecting the confirm link 2804B on user interface 2800B. Responsive to selecting the confirm link 2804B the first computer 102A issues a request to the web server 114 for the edited terms and conditions to be added to the workflow in step S2736. The request is then forwarded to the application server 116 in step S2738. Responsive to receiving the request in step S2738, the application server 116 issues a request to the database server 118 for the second user in the workflow, step S2740.

Responsive to receiving this request, the DBS 136 retrieves the details of the second user in the workflow in step S2742. The database server 118 then returns the details of the second user to the application server 116, step S2744.

The application server 116 calls a communications API from the API store through API interface 120 to prepare a request to the communications server 122 to send an email from the user to the entities to inform them of the change in terms and conditions for the workflow, step S2746. The email is configured to include an accept or deny choice and a selectable link to the terms and conditions so that the second user may see those terms and conditions.

Responsive to receiving the email, the second user clicks either accept or deny. The remainder of the process is described using FIG. 27b.

If the second user clicks accept, the second computer 102B issues a request to the web server 114 via the web interface 112, step S2748, for the amended terms and conditions to be accepted. Responsive to receiving the request in step S2748 the web server 114 issues a request to the application server 116 for the new terms and conditions to be saved as the terms and conditions for the workflow, step S2750.

The application server 116 then issues a request to the database server 118 for the new terms and conditions to be saved in the workflow data structure corresponding to the workflow in step S2752. The DBS 136 then saves the new terms and conditions in the workflow data structure, step S2754, and issues a confirmation message to the application server 116 that the new terms and conditions have been saved with a timestamp, step S2756.

If the second user clicks deny, the second computer 102B issues a request to the web server 114 via the web interface 112 in step S2758 for the amended terms and conditions to be denied. Responsive to receiving the request in step S2758, the web server 114 issues a request to the application server 116 for the new terms and conditions to be denied in step S2760. The application server 116 then calls the item access API from the store of APIs through API interface 120 with a request for the access token 1116 to be removed from the second user in a step S2762.

The access token 1116 is then removed and the second user cannot access that item any more.

The previous terms and conditions are each saved in order to enable the terms and conditions to be rolled back if necessary. The effect of this is that where a relationship between a first and second user is unstable and terms and conditions may change frequently, it is straightforward to transfer between agreements as a new set of terms and conditions simply replaces a previous set of terms and conditions.

### Passing the Share On

The system 100 may also act proactively on behalf of the first user when they have engaged in a workflow with a second user. Using the example of a share workflow between a first and second user as set out above, it is now described, with reference to FIG. 29, how the system acts to trace the sharing of an item that is stored on the third party data store 106 with particular interest in the item being shared to a third party (and more) outside of the system 100.

The first user is authenticated in the system 100 in accordance with steps S500 to S552 and therefore an access token 1116 has been stored in the corresponding user record 1104. The user has multiple items stored in the third party data store 106 but only one of which is the shared in the workflow that is characterised by workflow data structure 1102.

The user may initiate a periodic check on the items they have stored to check that those items are not being accessed by parties that should not be accessing those items. However, the application server 116 may also initiate a periodic check without input from the user.

In step S2900 the first user at first computer 102 may initiate a check on the items they have stored in the third party data store 106 by selecting an option from a menu in a user interface presented by application 110A. Responsive to the initiation of the check at the first computer 102, the first computer 102 issues a request for a check on the third party data store 106, step S2902 to the web server 114 via the web interface 112. Optionally, the check is initiated automatically at time intervals, typically periodically, under control of the application server 116. Responsive to receiving the request, the web server 114 issues a request for the check on the third party data store 106 to the application server 116 via the application interface 132, step S2904.

Responsive to receiving the request in step S2904, the application server 116 calls a polling API from the API store through API interface 120 to issue a request to the third party data store 106 for a transaction access log of all of the items the first user has stored on the third party data store 106, step S2906. The transaction access log comprises data relating to the users who have access to the files on the data store (enabled by the user outside of system 100 or within system 100), the last modified date of each of the files in the third party data store 106 and related metadata which may include the IP address used to access the item on the third party data store 106 and the location at which it was accessed. As the request relates to all of the items the user has stored on the third party data store 106, the system 100 allows the user to monitor all of the items in the third party data store 106 and not just the items that are the subject of a workflow using system 100, i.e. items where permissions have been granted by a user of system 100. The transaction access log lists all of the accesses that have taken place on each of the items stored by the user on the third party data store 106. The transaction log also lists details of who is accessing those items.

Responsive to receiving the transaction access log from the third party data store 106, the application server 116 compares the transaction access log with the submission data in storage 140, step S2908. The submission data lists all of the item access that has been enabled by the system 100 for the first user.

From the comparison in step S2908 the application server 116 returns a positive result or a negative result. If the comparison finds that the items stored on the third party data store 106 have only been accessed by users who should be accessing the items, the positive result is issued by the comparison in step S2908. If the comparison finds that items have been accessed by other entities that are not recorded in the submission data, the negative result is issued by the comparison in step S2910.

If a positive result is issued by step S2908, the check is finished and a confirmation is sent from the application server 116 to the web server 114, step S2910. Responsive to receiving the confirmation in step S2910, the web server 114 issues a confirmation message to the first computer 102, step S2912. Responsive to receiving the confirmation in step S2910, the processor 108A at the first computer 102A executes instructions to instruct the display to the display the confirmation, step S2912.

If a negative result is issued by step S2908, the application server 116 issues a query to the database server 118 to check if the user is likely to be sharing data of a confidential nature, step S2914. Responsive to receiving the query in step S2914, the DBS 136 is operative to interrogate the user record 1104 to find if the data therein indicates the user is likely to be sharing confidential data, step S2916. The DBS 136 is operative, following the interrogation in step S2916, then returns a result to the application server 116 either confirming the likelihood of confidential data or indicating that the data is not likely to be confidential, step S2918.

If the result returned to the application server 116 in step S2918 indicates the data is not likely to be confidential, the user risk is marked as low and entered into a risk calculation routine by the application server 116, step S2920. The application server 116 then queries the transaction log, step S2922 for the identity of the parties with whom the items have been shared and for each party an external data store may be queried, step S2924 for an assessment of the risk posed by those parties with a call to a risk data API from the library of APIs through API interface 120. The risk associated with each party is then returned to the application server stored by the external data store, step S2926. The application server 116 then stores the risk for each user (including users that are engaged in the workflow) in a lookup table in storage 140, step S2928.

The application server then queries the relational database 1100 for any legal relationships that may exist between the user and any parties that are accessing the items as set out in the transaction log by issuing a request to the database server 118, step S2930. Responsive to receiving the request in step S2930, the DBS 136 interrogates the database 134 for any legal relationships that are stored and between which parties the legal relationships exist. The DBS 136 returns to the application server 116 an indication of the legal relationships that have been stored in the workflow data structure 1102 in the relational database 1100, step S2932.

The legal relationships are assigned a risk value by the risk calculation routine, step S2934. The risk calculation routine then returns a risk value for each of the items that are set out in the transaction log and each of the parties accessing those items, step S2936. If the risk value for an item is high and the risk value for a party accessing that item is high, then a request is issued using the polling API for access to that item by that user to be prohibited. If the risk value for an item is high and the risk value for a party accessing that item is not high, then the application server 116 may call the polling API at a more regular interval to monitor the access to that item by that user. Other actions in respect of the item may be taken dependent on the granularity of the risk associated with the item and a user accessing the item. The application server 116 may then call the communications API to request that an email is transmitted to the first user to notify them that a poll has taken place of the files they have stored in the third party data store 106 and that access to an item has been prohibited. The user is given the option to reverse the option.

If the result returned to the application server 116 in step S2918 indicates the data is likely to be confidential, the user risk is marked as high and entered into the risk calculation routine by the application server 116, step S2938. The risk calculation module will then call the polling API to issue a request to the third party data store 106 for access to any one item to be restricted only to users who are engaged in a workflow involving that item, step S2940. The application server 116 may then call the communications API to request that an email is transmitted to the first user to request authorisation to restrict the access to the item only to users who are engaged in a workflow involving that item.

The effect of polling the third party data store 106 in this manner is that access to all of the users items may be monitored and controlled, even where the item on the data store has been accessed by many individuals outside of the system 100 and where successive generations of sharing has taken place.

### Time Limit

The email that is sent to the second user in accordance with steps S1700 to S1742 may be transmitted to the second user with a fixed time limit for response. The time limit may be in terms of seconds, hours, days, weeks, months or years. If the steps in accordance with steps S2200 to S2234 are not carried out before the time limit has expired, i.e. the item has not been accessed, the application server 116 issues a request to the database server 118 for the respective workflow data structure 1102 to be deleted. Responsive to receiving this request, the DBS 136 deletes the respective record from the relational database 134. The application server 116 also calls the item access API with a request for the access token 1116 in the third party data store 106 to be removed from the item (s) that are subject of the workflow.

If permissions have been granted or made on a third party data store 106 as part of the workflow creating the time-limited invitation, then at the point of disabling the unique URL in the invitation, the application server may initiate an API that would remove the second users permissions on the third party data store. (This effectively ensures complete security of the data asset)

If the second user then attempts to access the item from the second computer 102B, the cluster of servers 104 will deny access to the item.

This enables time based control over the access to the item that is stored in the third party data store 106 126. This is more secure as it means that the unique URL can only remain active for a certain amount of time before being used. The time limit can be implemented in such a way that it is dependent upon the number of times the item is accessed. However, the time limit may also be implemented in such a way that it is independent of how many times the item is accessed.

### Conditional Restriction

Responsive to initiation of a workflow in accordance with steps S900 to S926, the first user may impose a conditional restriction on the workflow that they have initiated with the second user.

The first user may specify in the workflow data structure 1102 a function, e.g. in field 1119, which may form the basis for the conditional restriction. The function may specify an API which will be stored in the API library through API interface 120. The API will be called at a regular frequency to request a value from a data provider.

For example, the data provider may provide environmental data such as temperature and humidity to a workflow involving a collaboration between a first user in the United Kingdom and a second user in India. The subject of the workflow may be connected to water availability in a part of India and the first user may want the second user to update data in an item stored in a third party data store 106 when the temperature in India and the subsequent water availability exceeds a certain level.

Responsive to the API call returning a temperature above a predefined threshold, the unique URL given to the item may be made active for a period of time sufficient to enable the data to be entered by the second user and then rendered inactive when the temperature decreases below the predefined threshold.

This increases the control that the first user can have over access to the item by the second user.

In another example, the first user may specify a functional restriction on the access to the item. The functional restriction may be on the IP address corresponding to the computer used to access the item. Responsive to the web server 114 receiving a request to access the item in accordance with steps S1900 to S1934, the application server 116 in step S1912 may compare the IP address of the requesting computer with a range of IP addresses stored in the user record 1104 as restricted IP addresses by issuing a request to the database server 118 for the IP address of the requesting computer to be compared with the range. The DBS 136 responds to the request by interrogating the user record 1104 in the relational database structure 1100 for the presence of a range of IP addresses which are restricted. If the IP address is within the range then the DBS 136 responds to the application server 116 with a request for access to be denied. If the IP address is not within the range then the DBS 136 responds to the application server 116 with a request for access to be allowed.

This enables geographic restrictions to be placed on item access which means that where there is a suspicion of hacking from a known area of the world, item access can be blocked.

Optionally or additionally, when a user wishes to initiate a share, the system may be configured to check if the user the creator of the data wishes to share with has an address that is associated with the originator other than the one the user typed in when initiating the share but has been used by the and creator user in the past allowing the creator to be promoted to share with that user's address to speed up the process of sharing. However, in the case that the alternative email addresses has never been used between the user and creator before the data of an alternative email address should never be shared until such time that the recipient has requested the share be associated with that alternative email address.

It is to be understood that any feature described in relation to any one embodiment may be used alone, or in combination with other features described, and may also be used in combination with one or more features of any other of the embodiments, or any combination of any other of the embodiments.

As used herein any reference to “one embodiment” or “an embodiment” means that a particular element, feature, structure, or characteristic described in connection with the embodiment is included in at least one embodiment. The appearances of the phrase “in one embodiment” or the phrase in “in an embodiment” in various places in the specification are not necessarily referring to the same embodiment.

Insofar as embodiments of the invention described above are implementable, at least in part, using a software-controlled programmable processing device such as a general purpose processor or special-purpose processor, digital signal processor, microprocessor, or other processing device, data processing apparatus or computer system it will be appreciated that a computer program for configuring a programmable device, apparatus or system to implement the foregoing described methods, apparatus and system is envisaged as an aspect of the present invention. The computer program may be embodied as any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Peri, Matlab, Pascal, Visual Basic, ActiveX, assembly language, machine code and so forth. A skilled person would readily understand that term “computer” in its most general sense encompasses programmable devices such as referred to above, and data processing apparatus and computer systems in whatever format they may arise, for example, desktop personal computer, laptop personal computer, tablet, smart phone or other computing device.

Suitably, the computer program is stored on a carrier medium in machine readable form, for example the carrier medium may comprise memory, removable or non-removable media, erasable or non-erasable media, writeable or re-writeable media, digital or analog media, hard disk, floppy disk,

Compact Disk Read Only Memory (CD-ROM), optical disk, magnetic media, magneto-optical media, removable memory cards or disks, various types of Digital Versatile Disk (DVD) subscriber identity module, tape, cassette solid-state memory. The computer program may be supplied from a remote source embodied in the communications medium such as an electronic signal, radio frequency carrier wave or optical carrier waves. Such carrier media are also envisaged as aspects of the present invention.

As used herein, the terms “comprises”, “comprising”, “includes”, “including”, “has”, “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the invention. This is done merely for convenience and to give a general sense of the invention. This description should be read to include one or at least one and the singular also includes the plural unless it is obvious that it is meant otherwise.

In view of the foregoing description it will be evident to a person skilled in the art that various modifications may be made within the scope of the invention. For example, although embodiments have been described using location information as the data other data items may be used such as bank details, security and personal details, legal documentation, investment and financial details. Additionally, privacy and security settings may be implemented so that the information returned from a user editable location information structure may be controlled and distributed according to the desires of the user who generated the location information therein. For example, although the location information token is assigned by the DBS as an index it may optionally or additionally be stored in its associated location information data structure such that it may be searched for within the DBS.

Although embodiments have been described utilising a user's email address for the user identity, it will be evident to a person of ordinary skill in the art that one or more entities within the described system may use a different form of username such as the first and last name of a user or some such other identifier.

Although embodiments have been described with reference to sharing with a second user the scope of the teaching herein is not restricted in such a way and an item may be shared with more than one user as part of a workflow outside of sharing with a defined group of users.

The terms “documents or “item” are not intended to be restricted to a text or graphics document, item or particular type thereof unless the context so requires but to encompass any item, object or other thing to which access, particularly shared access, is provided. Other things may include XML or other markup data, or generic data such Boolean, alphanumeric or other character or encrypted strings.

Although the described embodiment encrypts the URL of the item stored in the third party data storage 106 for storage in database 134 it is not necessary for an implementation of the inventive concept. The encryption enhance security of the URL data on the system store and inhibits a system user having access through the system to the clear URL. The URL of the item stored in the third party data storage 106 is only stored transiently by the system. That is to say it is stored as part of the encryption process in transient memory. Likewise, when the encrypted URL is decrypted the decrypted URL (i.e. the URL of the item in the third party data storage 106 in the clear), the decrypted URL is stored in transient memory only long enough for the redirection procedure to be effected.

Optionally or additionally, the system may provide for the encrypted URL to be provided by a third party, for example a trusted third party certification authority or the like.

Aspects in accordance with embodiments of the invention are enumerated in the following numbered clauses. Note that these embodiments are not claims intended for examination and are merely to set forth further exemplary embodiments.

1. Apparatus operative to provide intermediary gateway control for access to an item stored on a third party shareable data store, the apparatus operative to:
receive identification data identifying a first user having share access control to one or more items stored on a third party shareable data store;
establish access rights to the third party shareable data store utilising access rights of the first user for accessing the one or more items on the third party shareable data store; and
store the access rights in a first user data structure.

2. Apparatus according to claim 1, further operative to authenticate the first user with the third party shareable data store in order to establish the access rights.

3. Apparatus according to clause 1 or 2, wherein said access rights comprise an access token provided by the third party shareable data store for storage in the first user data structure.

4. Apparatus according to any preceding clause, further operative to receive restriction information for the first user and to store the restriction information in association with the first user.

5. Apparatus according to clause 4, further operative to store the restriction information in a restriction table and relate first user data structure to the restriction table.

6. Apparatus according to clause 5, further operative to index the restriction information in the restriction table by a first user id information.

7. Apparatus according to clause 6, wherein the restriction information is of a first or second type, the apparatus further operative to:
store in respective fields of the first user data structure a label for a respective one of the first or second type;
store in respective first and second restriction tables corresponding to each of the first and second type of restriction data defining one or more specific restrictions of the respective first and second type; and
index the respective fields of the first data structure with corresponding restriction data in respective first and second restriction tables by the first user id data.

8. Apparatus according to any preceding clause, further operative to:
receive from the first user identification data identifying a second user;
receive information representative of the storage location in the third party shareable data store of at least one item of the one or more items responsive to selection of the at least one item by the first user;
generate a key unique to the at least one second user and representative of the storage location in the third party shareable data store of the at least one item ;
store a concordance of the unique key and the information representative of the storage location for the at least one item;
store the unique key in a record of a first user workflow data structure, the first user workflow data structure further comprising a record identifying the second user;
index the first user data structure with the workflow data structure through the first user id data; and
provide the unique key to the second user identified in the workflow data structure.

9. Apparatus according to clause 8, further operative to identify the information representative of the storage location for the at least one item responsive to a second user supplying the unique key to the apparatus and redirecting the second user to a storage location on the third party shareable data storage corresponding to the information representative of the storage location for the at least one item.

10. Apparatus according to clause 8 or 9, further operative to encrypt the information representative of the storage location for the at least one item.

11. Apparatus according to clause 10 dependent on clause 9, further operative to decrypt the encrypted information representative of the storage location for the at least one item responsive to initiation of redirecting the second user.

12. Apparatus according to any of clauses 8 to 11 dependent on clauses 4 to 7, further operative to inspect a restriction associated with the first user to determine applicability of the restriction to the second user.

13. Apparatus according to clause 12, further operative to restrict access by the second user to the at least one item in accordance with a restriction applicable thereto.

14. Apparatus according to any of clauses 8 to 13, further operative to record a time stamp in the workflow data structure responsive to instantiation of the workflow data structure.

15. Apparatus according to clause 14, further operative to restrict access to the at least one item responsive to a time period from the date stamp having elapsed.

16. Apparatus according to any of clauses 8 to 15, further operative to remove concordance of the unique key and the information representative of the storage location for the at least one item to inhibit access of the second user to the at least one item .

17. Apparatus according to clause 16, wherein removal of the concordance comprises inhibiting the unique key in the workflow data structure.

18. Apparatus according to clause 16, wherein inhibiting the unique key comprises deleting it from the workflow data structure.

19. Apparatus according to any of clauses 16 to 18, further operative to request the third party shareable data storage to deny access to the at least one data item by the second user.

20. Apparatus according to any of clauses 8 to 19, further operative to record all interactions between the first user, second user and the at least one item.

21. Apparatus according to any preceding clause, further operative to:
maintain a subscription log logging access to the at least one item through the apparatus
request a transaction log listing access to the at least one item on the third party shareable data store;
compare the transaction log to the subscription log; and
restrict access to the at least one item based on the comparison.

22. Apparatus according to clause 21, further operative to restrict access for the comparison indicating a first user access rights being utilised to access items on the third party shareable data storage other than from the apparatus.

23. Apparatus according to clause 21 or 22, further operative to restrict access for the comparison indicating a first user access rights being utilised to access items on the third party shareable data storage other than the second user.

24. Apparatus according to any of clauses 4 to 23, further operative to receive updated restriction information and store the updated restriction information in association with the first user.

25. Apparatus according to clause 24, further operative to check restriction information at time intervals and update restriction on access for the second user in accordance with changes in restriction information.

26. Apparatus according to clause 24, further operative to set a flag responsive to a change in restriction information and to update restriction on access for the second user in accordance with changes in restriction information responsive to the set flag.

27. Apparatus according to any preceding clause, wherein the data identifying the first user and/or the second user is a data string.

28. Apparatus, according to clause 27, wherein the data string is an email address of the first user and/or second user.

29. Apparatus, according to clause 27 where the data string is an identity allocated by the apparatus.

30. A method of operating data processing apparatus to provide an intermediary gateway control for access to an item stored on a third party shareable data store, the method comprising:
receiving identification data identifying a first user having share access control to one or more items stored on a third party shareable data store;
establishing access rights to the third party shareable data store utilising access rights of the first user for accessing the one or more items on the third party shareable data store; and
storing the access rights in a first user data structure.

31. A method according to clause 30, further comprising authenticating the first user with the third party shareable data store in order to establish the access rights.

32. A method according to clause 30 or 31, wherein said access rights comprise an access token provided by the third party shareable data store for storage in the first user data structure.

33. A method according to any of clauses 30 to 32, further comprising receiving restriction information for the first user and storing the restriction information in association with the first user.

34. A method according to clause 33, further comprising storing the restriction information in a restriction table and relating first user data structure to the restriction table.

35. A method according to clause 34, further comprising indexing the restriction information in the restriction table by a first user id information.

36. A method according to clause 35, wherein the restriction information is of a first or second type, the method further comprising:
storing in respective fields of the first user data structure a label for a respective one of the first or second type;
storing in respective first and second restriction tables corresponding to each of the first and second type of restriction data defining one or more specific restrictions of the respective first and second type; and
indexing the respective fields of the first data structure with corresponding restriction data in respective first and second restriction tables by the first user id data.

37. A method according to any of clauses 30 to 36, further comprising:
receiving from the first user identification data identifying a second user;
receiving information representative of the storage location in the third party shareable data store of at least one item of the one or more items responsive to selection of the at least one item by the first user;
generating a key unique to the at least one second user and representative of the storage location in the third party shareable data store of the at least one item ;
storing a concordance of the unique key and the information representative of the storage location for the at least one item;
storing the unique key in a record of a first user workflow data structure, the first user workflow data structure further comprising a record identifying the second user;
indexing the first user data structure with the workflow data structure through the first user id data; and
providing the unique key to the second user identified in the workflow data structure.

38. A method according to clause 37, further comprising identifying the information representative of the storage location for the at least one item responsive to a second user supplying the unique key to the apparatus and redirecting the second user to a storage location on the third party shareable data storage corresponding to the information representative of the storage location for the at least one item.

39. A method according to clause 37 or 38, further comprising encrypting the information representative of the storage location for the at least one item.

40. A method according to clause 39 dependent on clause 38, further comprising decrypting the encrypted information representative of the storage location for the at least one item responsive to initiation of redirecting the second user.

41. A method according to any of clauses 37 to 40 dependent on clauses 33 to 36, further comprising inspecting a restriction associated with the first user to determine applicability of the restriction to the second user.

42. A method according to clause 41, further comprising restricting access by the second user to the at least one item in accordance with a restriction applicable thereto.

43. A method according to any of clauses 37 to 42, further comprising recording a time stamp in the workflow data structure responsive to instantiation of the workflow data structure.

44. A method according to clause 43, further comprising restricting access to the at least one item responsive to a time period from the date stamp having elapsed.

45. A method according to any of clauses 37 to 44, further comprising removing concordance of the unique key and the information representative of the storage location for the at least one item to inhibit access of the second user to the at least one item.

46. A method according to clause 45, wherein removal of the concordance comprises inhibiting the unique key in the workflow data structure.

47. A method according to clause 46, wherein inhibiting the unique key comprises deleting it from the workflow data structure.

48. A method according to any of clauses 45 to 47, further comprising requesting the third party shareable data storage to deny access to the at least one data item by the second user.

49. A method according to any of clauses 37 to 48, further comprising recording all interactions between the first user, second user and the at least one item.

50. A method according to any of clauses 30 to 49, further comprising:
maintaining a subscription log logging access to the at least one item through the apparatus requesting a transaction log listing access to the at least one item on the third party shareable data store;
comparing the transaction log to the subscription log; and restricting access to the at least one item based on the comparison.

51. A method according to clause 50, further comprising restricting access for the comparison indicating a first user access rights being utilised to access items on the third party shareable data storage other than from the apparatus.

52. A method according to clause 50 or 51, further comprising restricting access for the comparison indicating a first user access rights being utilised to access items on the third party shareable data storage other than the second user.

53. A method according to any of clauses 33 to S2, further comprising receiving updated restriction information and storing the updated restriction information in association with the first user.

54. A method according to clause 53, further comprising checking restriction information at time intervals and updating restriction on access for the second user in accordance with changes in restriction information.

55. A method according to clause 53, further comprising setting a flag responsive to a change in restriction information and updating restriction on access for the second user in accordance with changes in restriction information responsive to the set flag.

56. A method according to any of clauses 30 to 55, wherein the data identifying the first user and/or the second user is a data string.

57. A method according to clause 56, wherein the data string is an email address of the first user and/or second user.

58. A method according to clause 56 where the data string is an identity allocated by the apparatus.

59. A computer program comprising computer readable instructions executable to configure a computer in accordance with the apparatus of any of clauses 1 to 29 or to execute the steps of any of clauses 30 to 58.

60. A computer programmer carrier medium carrying a computer program according to clause 59.

61. A system comprising a third party shareable data store, a communications network and apparatus according to any of clauses 1 to 29 and wherein the third party shareable data store and apparatus operative to communicate across the country cases network with one another.

The scope of the present disclosure includes any novel feature or combination of features disclosed therein either explicitly or implicitly or any generalisation thereof irrespective of whether or not it relates to the claimed invention or mitigate against any or all of the problems addressed by the present invention. The applicant hereby gives notice that new claims may be formulated to such features during prosecution of this application or of any such further application derived therefrom. In particular, with reference to the appended claims, features from dependent claims may be combined with those of the independent claims and features from respective independent claims may be combined in any appropriate manner and not merely in specific combinations enumerated in the claims.

1. An apparatus operative to provide intermediary gateway control for access to an item stored on a third party shareable data store, the apparatus operative to:
a computer programmed to execute the following operations:
receive identification data identifying a first user having share access control to one or more items stored on a third party shareable data store;
establish access rights to the third party sharable data store utilising access rights of the first user for accessing the one or more items on the third party shareable data store;
store the access rights in a first user data structure; and
receive restriction information for the first user and to store the restriction information in association with the first user.

2-41. (canceled)

42. An apparatus according to claim 1, further operative to store the restriction information in a restriction table and relate first user data structure to the restriction table.

43. Apparatus according to claim 42, further operative to index the restriction information in the restriction table by a first user id information.

44. Apparatus according to claim 43, wherein the restriction information is of a first or second type, the apparatus further operative to:
store in respective fields of the first user data structure a label for a respective one of the first or second type;
store in respective first and second restriction tables corresponding to each of the first and second type of restriction data defining one or more specific restrictions of the respective first and second type; and
index the respective fields of the first data structure with corresponding restriction data in respective first and second restriction tables by the first user id data.

45. An apparatus according to claim 1, further operative to:
receive from the first user identification data identifying a second user;
receive information representative of the storage location in the third party shareable data store of at least one item of the one or more items responsive to selection of the at least one item by the first user;
generate a key unique to the at least one second user and representative of the storage location in the third party shareable data store of the at least one item;
store a concordance of the unique key and the information representative of the storage location for the at least one item;
store the unique key in a record of a first user workflow data structure, the first user workflow data structure further comprising a record identifying the second user;
index the first user data structure with the workflow data structure through the first user id data;
provide the unique key to the second user identified in the workflow data structure; and
record a time stamp in the workflow data structure responsive to instantiation of the workflow data structure.

46. An apparatus according to claim 48, further operative to identify the information representative of the storage location for the at least one item responsive to a second user supplying the unique key to the apparatus and redirecting the second user to a storage location on the third party shareable data storage corresponding to the information representative of the storage location for the at least one item.

47. An apparatus according to claim 45, further operative to inspect a restriction associated with the first user to determine applicability of the restriction to the second user.

48. An apparatus according to claim 47, further operative to restrict access by the second user to the at least one item in accordance with a restriction applicable thereto; and
record a time stamp in the workflow data structure responsive to instantiation of the workflow data structure.

49. An apparatus according to claim 1, further operative to restrict access to the at least one item responsive to a time period from the date stamp having elapsed.

50. An apparatus according to claim 47, further operative to receive updated restriction information and store the updated restriction information in association with the first user.

51. An apparatus according to claim 50, further operative to check restriction information at time intervals and update restriction on access for the second user in accordance with changes in restriction information.

52. An apparatus according to claim 50, further operative to set a flag responsive to a change in restriction information and to update restriction on access for the second user in accordance with changes in restriction information responsive to the set flag.

53. Apparatus according to claim 1, wherein the data identifying the first user and/or the second user is a data string.

54. An apparatus according to claim 52, wherein the data string is an email address of the first user and/or second user.

55. An apparatus, according to claim 53 where the data string is an identity allocated by the apparatus.

56. A method of operating data processing apparatus to provide an intermediary gateway control for access to an item stored on a third party shareable data store, the method comprising:
receiving identification data identifying a first user having share access control to one or more items stored on a third party shareable data store;
establishing access rights to the third party shareable data store utilising access rights of the first user for accessing the one or more items on the third party shareable data store;
storing the access rights in a first user data structure:
receiving restriction information for the first user and storing the restriction information in association with the first user; and
recording restriction information and storing the updated restriction information in association with the first user.

57. A computer program comprising computer readable instructions executable to configure a computer in accordance with the apparatus of claim 1.

58. A system comprising a third party shareable data store, a communications network and apparatus according to claim 1, wherein the third party shareable data store and apparatus operative to communicate across the country cases network with one another.

59. A method according to claim 56, further comprising receiving restriction information for the first user and storing the restriction information in association with the first user.

60. A method according to claim 59, further comprising storing the restriction information in a restriction table and relating first user data structure to the restriction table.

61. A method according to claim 60, further comprising indexing the restriction information in the restriction table by a first user id information

62. A method according to claim 61, wherein the restriction information is of a first or second type, the method further comprising:
storing in respective fields of the first user data structure a label for a respective one of the first or second type;
storing in respective first and second restriction tables corresponding to each of the first and second type of restriction data defining one or more specific restrictions of the respective first and second type; and
indexing the respective fields of the first data structure with corresponding restriction data in respective first and second restriction tables by the first user id data.

63. A method according to any of claim 59, further comprising:
receiving from the first user identification data identifying a second user;
receiving information representative of the storage location in the third party shareable data store of at least one item of the one or more items responsive to selection of the at least one item by the first user;
generating a key unique to the at least one second user and representative of the storage location in the third party shareable data store of the at least one item;
storing a concordance of the unique key and the information representative of the storage location for the at least one item;
storing the unique key in a record of a first user workflow data structure, the first user workflow data structure further comprising a record identifying the second user;
recording a time stamp in the workflow data structure responsive to instantiation of the workflow data structure;
recording restriction information and storing the updated restriction information in association with the first user;
indexing the first user data structure with the workflow data structure through the first user id data; and
providing the unique key to the second user identified in the workflow data structure.

64. A method according to claim 63, further comprising identifying the information representative of the storage location for the at least one item responsive to a second user supplying the unique key to the apparatus and redirecting the second user to a storage location on the third party shareable data storage corresponding to the information representative of the storage location for the at least one item.

65. A method according to claim 63, further comprising inspecting a restriction associated with the first user to determine applicability of the restriction to the second user.

66. A method according to claim 65, further comprising restricting access by the second user to the at least one item in accordance with a restriction applicable thereto.

67. A method according to claim 66, further comprising restricting access to the at least one item responsive to a time period from the date stamp having elapsed.

68. A method according to claim 67, further comprising checking restriction information at time intervals and updating restriction on access for the second user in accordance with changes in restriction information.

69. A method according to claim 68, further comprising setting a flag responsive to a change in restriction information and updating restriction on access for the second user in accordance with changes in restriction information responsive to the set flag.

70. A method according to claim 68, wherein the data identifying the first user and/or the second user is a data string.

71. A method according to claim 70, wherein the data string is an email address of the first user and/or second user.

72. A method according to claim 71, where the data string is an identity allocated by the apparatus.

73. A computer program carrier medium carrying a computer program according to claim 56.

74. A method according to claim 30, further comprising receiving restriction information for the first user and storing the restriction information in association with the first user.

75. A method according to claim 71, further comprising receiving restriction information for the first user and storing the restriction information in association with the first user.

76. A method according to claim 63, further comprising inspecting a restriction associated with the first user to determine applicability of the restriction to the second user.

77. A computer program comprising computer readable instructions executable to configure a computer in accordance with the execution of steps of claim 58.

78. A method according to claim 63, further comprising:
receiving from the first user identification data identifying a second user;
receiving information representative of the storage location in the third party shareable data store of at least one item of the one or more items responsive to selection of the at least one item by the first user;
generating a key unique to the at least one second user and representative of the storage location in the third party shareable data store of the at least one item;
storing a concordance of the unique key and the information representative of the storage location for the at least one item;
storing the unique key in a record of a first user workflow data structure, the first user workflow data structure further comprising a record identifying the second user;
recording a time stamp in the workflow data structure responsive to instantiation of the workflow data structure;
recording restriction information and storing the updated restriction information in association with the first user;
indexing the first user data structure with the workflow data structure through the first user id data; and
providing the unique key to the second user identified in the workflow data structure.

79. A computer program carrier medium carrying a computer program according to claim 78.
